(19) United States
(12) Patent Application Publication
(10) Pub. No.: US 2025/0141585 A1
(43) Pub. Date: May 1, 2025

(54) COMMUNICATION METHOD AND DEVICE

(71) Applicant: Huawei Technologies Co., Ltd., Shenzhen (CN)

(72) Inventors: Amirhossein Mohammadian, Ottawa (CA); Ahmed Mohamed Medra, Kanata (CA); Chuandong Li, Ottawa (CA)

(21) Appl. No.: 18/494,408

(22) Filed: Oct. 25, 2023

(51) Int. Cl. H04J 14/02

(52) U.S. Cl. CPC H04J 14/0298; H04J 14/0221; H04J 14/0238

(57) ABSTRACT

Embodiments of this disclosure provide a communication method and device. In the disclosure, when the first device and the second device in the Point-to-Multipoint network communicate with each other, if there is a first channel in inactive state between the two devices, which is active between the second device and the third device, and there is a second channel in inactive state between the second device and the third device, the second channel will be adopted to transmit the signal on the first channel, and then the state of the first channel will be changed to inactive state. After that, the state of the first channel between the first device and the second device will be changed to active state.

### TECHNICAL FIELD

The present disclosure relates to the field of communication technologies, and in particular, to a communication method and device.

### BACKGROUND

In the field of communication technology, P2MP (Point-to-Multipoint) optical network is a communication network that can provide multiple channels from a single location to multiple locations, thus enabling one device to communicate with multiple devices simultaneously. In addition, the network is usually combined with digital sub-carrier multiplexing method, dividing the communication channel between two devices into multiple sub-channels (sub-carriers). Thus, these two devices can simultaneously transmit and receive multiple signals through multiple sub-channels.

Taking the P2MP network shown in FIG. 1 as an example, there are four devices in FIG. 1: HUB, AP1, AP2 and AP3. In this network, HUB can communicate with AP1, AP2 and AP3 respectively. The channel between AP2 and HUB includes two sub-carriers, namely sub-carrier 3 and sub-carrier 4; the channel between AP3 and HUB includes sub-carrier 4 and sub-carrier 5. In the network shown in FIG. 1, sub-carrier 4 is assigned to AP2 and AP3, but only one AP (either AP2 or AP3) can communicate with HUB through sub-carrier 4. For example, if AP2 cannot communicate with HUB through sub-carrier 4 and AP3 can communicate with HUB through sub-carrier 4, the frequency range occupied by sub-carrier 4 at the AP2 side will be wasted, resulting in weak signal transmission capacity between AP2 and HUB.

Therefore, in the P2MP network combined with digital sub-carrier multiplexing method, if a sub-carrier is assigned to multiple devices and only one of the multiple devices can communicate based on the sub-carrier, other devices that cannot communicate based on the sub-carrier would have lower signal transmission capacity. In this case, how to improve the signal transmission capacity of devices that cannot communicate based on the sub-carrier, so as to further enhance the signal transmission capacity of P2MP network, is a technical problem that needs to be solved.

### SUMMARY

The following examples pertain to embodiments described throughout this disclosure.

One or more embodiments can include a first device. The first device comprising: at least one processor; and a memory storing instructions executable by the at least one processor, wherein execution of the instructions causes the first device to: transmit a first request to a second device when detecting channels between the first device and the second device including a first channel in an inactive state, wherein the first request is used to request state shift of the first channel from an inactive state to an active state; receive a first instruction from the second device, wherein the first instruction is used to instruct the first device to transmit signals through the first channel to the second device; communicate with the second device through the first channel, making state of the first channel to be shifted into an active state.

In some implements of the first device (AP2 mentioned in the following content), when detecting there is an inactive first channel (the first sub-carrier mentioned in the following content) between the first device and the second device (HUB mentioned in the following content), the first channel can transmit a first request to a second device and then the first channel can become active between the first device and the second device. In this way, the first device and the second device can communicate with each other based on the first channel, avoiding the waste of the frequency range occupied by the first channel, and improving the signal transmission capacity between the first device and the second device.

One or more embodiments can include a second device. The second device comprising: a memory for storing instructions; one or more processors for executing the instructions to cause the second device to: receive a first request from a first device, wherein the first request is used to request state shift of a first channel between the first device and the second device from an inactive state to an active state; transmit a first signal through a second channel to a third device, when detecting channels between the second device and the third device including the second channel in an inactive state and the first channel in an active state, wherein the first signal is a signal formerly transmitted by the second device to the third device through the first channel; communicate with the first device through the first channel, making state of the first channel between the first device and the second device to be shifted into an active state.

By doing so, the second device can communicate with the first device through the first channel, and what's more, the second device can still communicate with the third device (AP3 mentioned in the following content) because the second channel (the second sub-carrier mentioned in the following content) between the second device and the third device has become active. Thus, the signal transmission capacity between the first device and the second device has been improved without affecting the communication between the second device and the third device.

One or more embodiments can include a second device, wherein the instructions further instruct the at least one processor to: adjust power of the second channel from a first power to a second power during time periods when the second device transmits the first signal to the third device through the second channel, wherein the first power is power of the second channel in an inactive state and the second power is power when the second channel transmits the first signal; wherein adjusting number of times is a first number of times, power shift value adjusted for each time period is quotient of difference between the first power and the second power and the first number of times, and length of each time period is quotient of total length of time required to adjust the first power to the second power and the first number of times.

It can be understood that when the second device transmits the first signal to the third device through the second channel, the second channel's power can be gradually increased, thereby preventing the communication between the third device and the second device from being interrupted because of the sudden change of the second channel's power.

One or more embodiments can include a second device, wherein transmit a first signal through a second channel to a third device, comprises: copy the signal formerly transmitted by the second device into the second channel, thus achieving a first signal; transmit the first signal to the third device through the second channel.

One or more embodiments can include a second device, wherein the instructions further instruct the at least one processor to: shift state of the first channel into an inactive state when a first communication condition is met.

One or more embodiments can include a second device, wherein shift state of the first channel into an inactive state when a first communication condition is met, comprises: adjust power of the first channel from a third power to a fourth power during time periods, wherein the third power is power of the first channel in an active state and the fourth power is power of the first channel in an inactive state; wherein adjusting number of times is a second number of times, power shift value adjusted for each time period is quotient of difference between the third power and the fourth power and the second number of times, and length of each time period is quotient of total length of time required to adjust the third power to the fourth power and the second number of times.

It can be understood that when state of the first channel is shifted into inactive state, the first channel's power can be gradually decreased, thereby preventing the communication between the third device and the second device from being interrupted because of the sudden change of the first channel's power.

One or more embodiments can include a second device, wherein the first communication condition comprises: transmit a second signal through the first channel to the third device, when transmitting the first signal through the second channel to the third device, wherein the first signal and the second signal are the same; receive a first message from the third device, wherein the first message is used to indicate the third device has received the first signal and the second signal; and, align pointers to start of frame of a third signal and a fourth signal, wherein the third signal is received by the second device through the second channel from the third device, the fourth signal is received by the second device through the first channel from the third device, and the third signal and the fourth signal are the same.

One or more embodiments can include a second device, wherein align pointers to start of frame of a third signal and a fourth signal, comprises: calculate a cross-correlation function of the third signal and the fourth signal, wherein the cross-correlation function is used to indicate a time delay between the third signal and the fourth signal; align pointers to start of frame of the third signal and the fourth signal based on the cross-correlation function.

Based on the time delay, an alignment operation between the third signal and the fourth signal can be achieved. By doing so, an out-of-synchronization problem of the signals can be avoided.

One or more embodiments can include a second device, wherein the instructions further instruct the at least one processor to: transmit a first instruction to the first device when the second device transmits signals through the first channel to the first device, wherein the first instruction is used to instruct the first device to transmit signals to the second device through the first channel.

One or more embodiments can include a second device, wherein the instructions further instruct the at least one processor to: transmit a second instruction to the third device after the second device communicates with the first device through the first channel, wherein the second instruction is used to instruct the third device to shift state of the first channel into an inactive state between the second device and the third device.

One or more embodiments can include a third device. The third device comprising: a memory for storing instructions; one or more processors for executing the instructions to cause the third device to: receive a third instruction from a second device; receive a first signal through a second channel from the second device, and shift state of the first channel between the third device and the second device into an inactive state in response to the third instruction, wherein the first signal is a signal formerly transmitted by the second device to the third device through the first channel.

One or more embodiments can include a third device, wherein shift state of the first channel between the third device and the second device into an inactive state, comprises: adjust power of the first channel from a fifth power to a sixth power during time periods, wherein the fifth power is power of the first channel in an active state and the sixth power is power of the first channel in an inactive state; wherein adjusting number of times is a third number of times, power shift value adjusted for each time period is quotient of difference between the fifth power and the sixth power and the third number of times, and length of each time period is quotient of total length of time required to adjust the fifth power to the sixth power and the third number of times.

One or more embodiments can include a third device, wherein the instructions cause the third device to: receive a second signal through the first channel from the second device when receiving the first signal, wherein the first signal and the second signal are the same; align pointers to start of frame of the first signal and the second signal.

One or more embodiments can include a third device, wherein align pointers to start of frame of the first signal and the second signal, comprises: calculate a cross-correlation function of the first signal and the second signal, wherein the cross-correlation function is used to indicate a time delay between the first signal and the second signal; align pointers to start of frame of the first signal and the second signal based on the cross-correlation function.

One or more embodiments can include a third device, wherein the instructions cause the third device to: transmit a third signal through the second channel to the second device in response to the third instruction, wherein the third signal is a signal formerly transmitted by the third device to the second device through the first channel.

One or more embodiments can include a third device, wherein transmit a third signal through the second channel to the second device, comprises: copy the signal formerly transmitted by the third device into the second channel, thus achieving a third signal; transmit the third signal to the second device through the second channel.

One or more embodiments can include a third device, wherein the instructions cause the third device to: adjust power of the second channel from a seventh power to an eighth power during time periods when the third device transmits the third signal to the second device, wherein the seventh power is power of the second channel in an inactive state and the eighth power is power when the second channel transmits the third signal; wherein adjusting number of times is a fourth number of times, power shift value adjusted for each time period is quotient of difference between the seventh power and the eighth power and the fourth number of times, and length of each time period is quotient of total length of time required to adjust the seventh power to the eighth power and the fourth number of times.

One or more embodiments can include a third device, wherein the instructions cause the third device to: receive a second instruction; change the first channel between the second device and the third device through shifting frequency range of the third device in response to the second instruction.

One or more embodiments can include a third device, wherein the frequency range of the third device includes an analog frequency range and a digital frequency range; and, change the first channel between the second device and the third device through shifting frequency range of the third device in response to the second instruction, comprises: shift the third device's analog frequency range based on a frequency shift step, making the third device's frequency range not include the first channel's frequency range, and making the third device's frequency range include the second channel's frequency range allowing for future upgrade; shift the third device's digital frequency range based on a fractional digital frequency shift method or a subcarrier recovery method, to compensate a fractional part of the frequency shift step; shift the third device's digital frequency range based on a de-multiplexing method, to compensate an integer part of the frequency shift step.

One or more embodiments can include a communication method. The method can be applied in P2MP communication network including a first device, a second device and a third device. The method comprising: transmitting a first request, by the first device, to the second device when detecting channels between the first device and the second device including a first channel in an inactive state, wherein the first request is used to request state shift of the first channel between the first device and the second device from an inactive state to an active state; transmitting a first signal, by the second device, through a second channel to the third device when receiving the first request and detecting channels between the second device and the third device including the second channel in an inactive state and the first channel in an active state, wherein the first signal is a signal formerly transmitted by the second device to the third device through the first channel; and, shifting state of the first channel between the first device and the second device from an inactive state into an active state.

In this way, the first device and the second device can communicate with each other based on the first channel, avoiding the waste of the frequency range occupied by the first channel, and improving the signal transmission capacity between the first device and the second device. In addition, the second device can still communicate with the third device because the second channel between the second device and the third device has become active. The method improves the signal transmission capacity between the first device and the second device without affecting the communication between the second device and the third device, and increases the baud rate of the first device, realizing the hitless upgrade of P2MP network.

One or more embodiments can include a communication method, further comprising: transmitting a second signal, by the second device, through the first channel to the third device, when transmitting the first signal through the second channel to the third device, wherein the first signal and the second signal are the same; aligning, by the third device, pointers to start of frame of the first signal and the second signal; shifting the first channel's state, by the second device and the third device, to an inactive state between the second device and the third device.

One or more embodiments can include a communication method, wherein transmitting a first signal, by the second device, through a second channel to the third device, comprises: copying, by the second device, the signal formerly transmitted by the second device into the second channel, and achieving a first signal; transmitting the first signal, by the second device, to the third device through the second channel.

One or more embodiments can include a communication method, further comprising: sending a fourth instruction, by the second device, to the third device when transmitting the first signal through the second channel to the third device, wherein the fourth instruction is used to instruct the third device to receive the first signal through the second channel and transmit signals to the second device through the second channel.

One or more embodiments can include a communication method, wherein the state of the first channel between the first device and the second device is shifted from an inactive state into an active state, comprises: transmitting signals, by the second device, to the first device through the first channel between the first device and the second device; and, transmitting signals, by the first device, to the second device through the first channel between the first device and the second device.

One or more embodiments can include a communication method, further comprising: sending a second instruction, by the second device, to the third device after the first channel's state is shifted from an inactive state to an active state between the first device and the second device; changing the first channel, by the third device, between the second device and the third device through shifting frequency range of the third device in response to the second instruction.

One or more embodiments can include a communication method, wherein the first device is AP, the second device is HUB, and the third device is AP.

One or more embodiments can include a communication method. The method comprising: transmitting a first request, by a first device, to a second device when detecting channels between the first device and the second device including a first channel in an inactive state, wherein the first request is used to request state shift of the first channel from an inactive state to an active state; receiving a first instruction, by the first device, from the second device, wherein the first instruction is used to instruct the first device to transmit signals through the first channel to the second device; communicating with the second device, by the first device, through the first channel, making state of the first channel to be shifted into an active state.

One or more embodiments can include a communication method. The method comprising: receiving, by a second device, a first request from a first device, wherein the first request is used to request state shift of a first channel between the first device and the second device from an inactive state to an active state; transmitting a first signal, by the second device, through a second channel to a third device when detecting channels between the second device and the third device including the second channel in an inactive state and the first channel in an active state, wherein the first signal is a signal formerly transmitted by the second device to the third device through the first channel; communicating with the first device, by the second device, through the first channel, making state of the first channel to be shifted into an active state.

One or more embodiments can include a communication method, further comprising: adjusting power of the second channel, by the second device, from a first power to a second power during time periods when the second device transmits the first signal to the third device through the second channel, wherein the first power is power of the second channel in an inactive state and the second power is power when the second channel transmits the first signal; wherein adjusting number of times is a first number of times, power shift value adjusted for each time period is quotient of difference between the first power and the second power and the first number of times, and length of each time period is quotient of total length of time required to adjust the first power to the second power and the first number of times.

One or more embodiments can include a communication method, wherein transmitting a first signal, by the second device, through a second channel to the third device, comprises: copying, by the second device, the signal formerly transmitted by the second device into the second channel, and achieving a first signal; transmitting the first signal, by the second device, to the third device through the second channel.

One or more embodiments can include a communication method, further comprising: shifting state of the first channel, by the second device, into an inactive state when a first communication condition is met.

One or more embodiments can include a communication method, wherein shifting state of the first channel, by the second device, into an inactive state when a first communication condition is met, comprises: adjusting power of the first channel, by the second device, from a third power to a fourth power during time periods, wherein the third power is power of the first channel in an active state and the fourth power is power of the first channel in an inactive state; wherein adjusting number of times is a second number of times, power shift value adjusted for each time period is quotient of difference between the third power and the fourth power and the second number of times, and length of each time period is quotient of total length of time required to adjust the third power to the fourth power and the second number of times.

One or more embodiments can include a communication method, wherein the first communication condition comprises: transmitting a second signal, by the second device, through the first channel to the third device, when transmitting the first signal through the second channel to the third device, wherein the first signal and the second signal are the same; receiving a first message, by the second device, from the third device, wherein the first message is used to indicate the third device has received the first signal and the second signal; and, aligning, by the second device, pointers to start of frame of a third signal and a fourth signal, wherein the third signal is received by the second device through the second channel from the third device, the fourth signal is received by the second device through the first channel from the third device, and the third signal and the fourth signal are the same.

One or more embodiments can include a communication method, wherein aligning, by the second device, pointers to start of frame of a third signal and a fourth signal, comprises: calculating a cross-correlation function, by the second device, of the third signal and the fourth signal, wherein the cross-correlation function is used to indicate a time delay between the third signal and the fourth signal; aligning, by the second device, pointers to start of frame of the third signal and the fourth signal based on the cross-correlation function.

One or more embodiments can include a communication method, further comprising: transmitting a first instruction, by the second device, to the first device when the second device transmits signals through the first channel to the first device, wherein the first instruction is used to instruct the first device to transmit signals to the second device through the first channel.

One or more embodiments can include a communication method, further comprising: transmitting a second instruction, by the second device, to the third device after the second device communicates with the first device through the first channel, wherein the second instruction is used to instruct the third device to shift state of the first channel into an inactive state between the second device and the third device.

One or more embodiments can include a communication method. The method comprising: receiving a third instruction, by a third device, from a second device; receiving a first signal, by the third device, through a second channel from the second device, and shifting state of the first channel between the third device and the second device into an inactive state in response to the third instruction, wherein the first signal is a signal formerly transmitted by the second device to the third device through the first channel.

One or more embodiments can include a communication method, wherein shifting state of the first channel between the third device and the second device into an inactive state, comprises: adjusting power of the first channel, by the third device, from a fifth power to a sixth power during time periods, wherein the fifth power is power of the first channel in an active state and the sixth power is power of the first channel in an inactive state; wherein adjusting number of times is a third number of times, power shift value adjusted for each time period is quotient of difference between the fifth power and the sixth power and the third number of times, and length of each time period is quotient of total length of time required to adjust the fifth power to the sixth power and the third number of times.

One or more embodiments can include a communication method, further comprising: receiving a second signal, by the third device, through the first channel from the second device when receiving the first signal, wherein the first signal and the second signal are the same; aligning, by the third device, pointers to start of frame of the first signal and the second signal.

One or more embodiments can include a communication method, wherein aligning, by the third device, pointers to start of frame of the first signal and the second signal, comprises: calculating a cross-correlation function, by the third device, of the first signal and the second signal, wherein the cross-correlation function is used to indicate a time delay between the first signal and the second signal; aligning, by the third device, pointers to start of frame of the first signal and the second signal based on the cross-correlation function.

One or more embodiments can include a communication method, further comprising: transmitting a third signal, by the third device, through the second channel to the second device in response to the third instruction, wherein the third signal is a signal formerly transmitted by the third device to the second device through the first channel.

One or more embodiments can include a communication method, wherein transmitting a third signal, by the third device, through the second channel to the second device, comprises: copying, by the third device, the signal formerly transmitted by the third device into the second channel, and achieving a third signal; transmitting the third signal, by the third device, to the second device through the second channel.

One or more embodiments can include a communication method, further comprising: adjusting power of the second channel, by the third device, from a seventh power to an eighth power during time periods when the third device transmits the third signal to the second device, wherein the seventh power is power of the second channel in an inactive state and the eighth power is power when the second channel transmits the third signal; wherein adjusting number of times is a fourth number of times, power shift value adjusted for each time period is quotient of difference between the seventh power and the eighth power and the fourth number of times, and length of each time period is quotient of total length of time required to adjust the seventh power to the eighth power and the fourth number of times.

One or more embodiments can include a communication method, further comprising: receiving a second instruction, by the third device; changing the first channel, by the third device, between the second device and the third device through shifting frequency range of the third device in response to the second instruction.

One or more embodiments can include a communication method, wherein the frequency range of the third device includes an analog frequency range and a digital frequency range; and, changing the first channel, by the third device, between the second device and the third device through shifting frequency range of the third device in response to the second instruction, comprises: shifting the third device's analog frequency range, by the third device, based on a frequency shift step, making the third device's frequency range not include the first channel's frequency range, and making the third device's frequency range include the second channel's frequency range allowing for future upgrade; shifting the third device's digital frequency range, by the third device, based on a fractional digital frequency shift method or a subcarrier recovery method, to compensate a fractional part of the frequency shift step; shifting the third device's digital frequency range, by the third device, based on a de-multiplexing method, to compensate an integer part of the frequency shift step.

### BRIEF DESCRIPTION OF THE DRAWINGS

To illustrate more clearly the technical features in embodiments of this disclosure, a brief description of the drawings in the description of embodiments is provided below. Obviously, the drawings in the following description are only some examples of this disclosure. For the general technical personnel in this art, other drawings can be obtained based on these drawings without creative labor.

FIG. 1 shows a schematic structural diagram of a P2MP network according to some embodiments of the present disclosure;

FIG. 2 shows a schematic flow diagram of digital signal processing at transmitter during P2MP network's communication process, according to some embodiments of the present disclosure;

FIG. 3 shows a schematic flow diagram of digital signal processing at receiver during P2MP network's communication process, according to some embodiments of the present disclosure;

FIG. 4 shows a schematic diagram of an initial configuration of P2MP network and the state of sub-carriers, according to some embodiments of the present disclosure;

FIG. 5A shows a schematic diagram of a target configuration of P2MP network and the state of sub-carriers, according to some embodiments of the present disclosure;

FIG. 5B shows a schematic diagram of another kind of target configuration of P2MP network and a state of sub-carriers, according to some embodiments of the present disclosure;

FIG. 5C shows a schematic flow diagram of a communication method of P2MP network, according to some embodiments of the present disclosure;

FIG. 6 shows a schematic flow diagram of a communication method in the downlink, according to some embodiments of the present disclosure;

FIG. 7 shows a schematic flow diagram for gradually increasing the power of a sub-carrier, according to some embodiments of the present disclosure;

FIG. 8 shows a schematic flow diagram of digital signal processing including power scaling step at transmitter, according to some embodiments of the present disclosure;

FIG. 9 shows a schematic flow diagram of digital signal processing including sub-carrier alignment step at receiver, according to some embodiments of the present disclosure;

FIG. 10 shows a schematic flow diagram for gradually decreasing the power of a sub-carrier, according to some embodiments of the present disclosure;

FIG. 11 shows a schematic flow diagram of digital signal processing including fractional digital frequency shift step at receiver, according to some embodiments of the present disclosure;

FIG. 12 shows a detailed schematic flow diagram of fractional digital frequency shift step, according to some embodiments of the present disclosure;

FIG. 13 shows a schematic flow diagram of a compensation method for analog center frequency shift, according to some embodiments of the present disclosure;

FIG. 14 shows a schematic flow diagram of a communication method in the uplink, according to some embodiments of the present disclosure;

FIG. 15 shows a schematic flow diagram of digital signal processing including fractional digital frequency shift step at transmitter, according to some embodiments of the present disclosure;

FIG. 16 shows a schematic diagram of a communication process between AP2 and HUB in the case of capacity upgrade request, according to some embodiments of the present disclosure;

FIG. 17 shows a schematic diagram of a communication process between AP3 and HUB during AP3's upgrade process, according to some embodiments of the present disclosure;

FIG. 18 shows a schematic diagram of a process in which HUB and AP3 no longer communicate with each other based on sub-carrier 4, according to some embodiments of the present disclosure;

FIG. 19 shows a schematic diagram of a communication process between AP2 and HUB during AP2's upgrade process, according to some embodiments of the present disclosure;

FIG. 20 shows a schematic diagram of a communication process between AP3 and HUB during AP3's center frequency shift process, according to some embodiments of the present disclosure;

FIG. 21 shows a schematic structural diagram of an electronic device 1400, according to some embodiments of the present disclosure.

### DETAILED DESCRIPTION

Illustrative embodiments of the present disclosure include, but are not limited to, communication method and device.

First of all, the related terms in embodiments of the present disclosure are explained.

Sub-carrier: During transmission of a signal, it is necessary to interact the signal with a wave of a fixed frequency. That is to say, the signal should be transmitted based on a wave with fixed frequency. In the present disclosure, the wave with fixed frequency is called sub-carrier.

Multiplexing technology: A technology for transmitting multiplexed signals on one communication channel to improve the utilization rate of the communication channel. When the bandwidth of the channel is relatively large, and the transmitted signal can be efficiently transmitted only by a part of the bandwidth, multiple signals can be simultaneously transmitted in the channel, and each signal occupies a part of the bandwidth.

Multiplexer: A circuit that accepts multiple signals (sub-carriers) simultaneously, each occupying a part of the bandwidth, and generates one signal that occupies the entire transmission bandwidth.

Carrier recovery: In the field of digital communication and the like, the original signal is destroyed or distorted due to various kinds of interference, loss, and impairments in the transmission channel. In this case, it is necessary to recover the distorted signal through the carrier recovery technique to improve the quality and reliability of the signal transmitted.

The background of the communication method provided in the embodiment of the present disclosure is explained below.

With the continuous development of contemporary social networks, there is an increasing demand for higher transmission rate and larger transmission capacity of communication network, which promotes the emergence and development of various technologies related to optical communication. The P2MP network is one of them. The P2MP network can provide multiple channels from a single location to multiple locations, thus enabling one device to communicate with multiple devices simultaneously. What's more, in combination with digital sub-carrier multiplexing method, the network enables two devices to simultaneously transmit and receive multiple signals through multiple sub-channels. Hence, the network is characterized by high efficiency, high flexibility and low running cost.

The P2MP network typically includes a primary transceiver (e.g., HUB) and a plurality of secondary transceivers (e.g., Access Points, APs), and HUB can communicate with each AP. In the embodiments of the disclosure, the transceiver is an electronic device capable of both transmitting and receiving signals. Taking the first transceiver communicates with the second transceiver as an example, if the first transceiver transmits a signal, the second transceiver receives the signal. If the second transceiver transmits a signal to the first transceiver, the first transceiver can receive the signal sent by the second transceiver.

For the convenience of description, it is necessary to take the P2MP network including one HUB and multiple APs as an example to describe embodiments of this disclosure. For such a network, HUB is considered to be the master node, ΔP is the secondary node in the network, and HUB can generate multiple sub-carriers. Each ΔP can communicate with HUB through sub-carriers generated by HUB. That is to say, each ΔP is assigned to one or more sub-carriers generated by HUB. For example, if an ΔP is assigned to two sub-carriers generated by HUB, HUB can communicate with ΔP through these two sub-carriers.

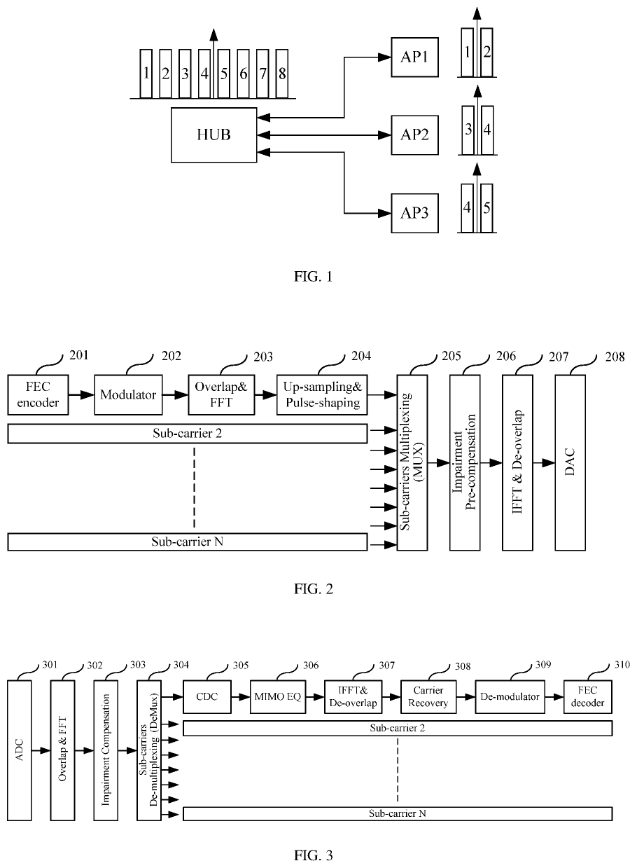

FIG. 1 shows a schematic structural diagram of a P2MP network. As shown in FIG. 1, the network includes four nodes, one HUB and three APs. That is to say, HUB can communicate with each AP. In addition, HUB in FIG. 1 generates eight different sub-carriers, with each occupying a different frequency range, and each ΔP is assigned to two different sub-carriers generated by HUB. For example, AP1 is assigned to sub-carrier 1 and sub-carrier 2 generated by HUB; AP2 is assigned to sub-carrier 3 and sub-carrier 4 generated by HUB; AP3 is assigned to sub-carrier 4 and sub-carrier 5 generated by HUB, and sub-carrier 6, sub-carrier 7 and sub-carrier 8 do not have assigned APs.

The P2MP network shown in FIG. 1 includes a downlink and an uplink, which means communication between HUB and each ΔP is bi-directional. In the downlink, HUB transmits signals (otherwise referred to as data) to its corresponding ΔP through a sub-carrier. In this case, HUB is the transmitter and ΔP is the receiver. In the uplink, ΔP transmits signals (otherwise referred to as data) to HUB through a sub-carrier. In this case, ΔP is the transmitter and HUB is the receiver.

FIG. 2 shows a schematic flow diagram of a digital signal processing at transmitter during P2MP network's communication process. It can be understood that the transmitter can be either a HUB or an AP. FIG. 2 includes N (N>=1) sub-carriers in which the signal transmitted by each sub-carrier first goes through 201 to be encoded by a Forward Error Correction (FEC) encoder. The FEC encoder may also generate redundant bits during encoding of the signal, and add the redundant bits to the signal to enable the receiver to detect and correct any possible limited number of errors in the signal, thereby enabling Forward Error Correction of the signal transmitted on the sub-carrier.

After the signal transmitted on each sub-carrier is encoded, 202 is needed in the following steps. The signal can be modulated by the digital modulator which encodes digital information bits into the frequency, amplitude, or phase of the signal. In other words, the digital modulator encodes the FEC encoded bits into constellation symbols.

Then, a Fast Fourier Transform (FFT) is performed on the signal applied to each sub-carrier (203 in FIG. 2) to convert a time-domain signal into a frequency-domain signal, and operations such as windowing and overlapping may be performed on the signal in the process of the Fast Fourier Transform. The windowing is performed so as to prevent leakage of a spectrum, and the overlapping is performed so as to prevent the amplitude of the signal from being distorted when the signal is converted to the time domain through Inverse Fast Fourier Transform (IFFT). The larger the proportion of overlapping, the smaller the distortion of the windowed signal.

After the signal applied to each sub-carrier is converted to the frequency domain by FFT, and before the multiplexing technique of the signal is performed, the up-sampling operation and pulse-shaping operation (204 in FIG. 2) need to be performed on the signal. The up-sampling operation means resampling of the signal, and the sample rate of re-sampled signal needs to be larger than that of the original obtained signal, so as to improve the accuracy of the signal obtained by up-sampling.

The signal can then go through pulse shaping to change the pulse waveform of the signal. In this way, by performing a filtering operation on the signal, the inter-symbol interference in the signal transmission process is reduced, so that the signal is more suitable for the frequency range of the corresponding sub-carrier.

After pulse shaping, signals applied to N sub-carriers need to go through 205 to be integrated, and the multiplexing technique is performed. The multiplexing method is not limited in the embodiments of the present disclosure. Illustratively, the signals applied to N sub-carriers can be input to a multiplexer (Mux) to be multiplexed.

After multiple signals are multiplexed, impairment phenomena such as amplitude difference and/or non-orthogonal phase may occur. In this case, in-phase and quadrature skew of the signals may occur. Therefore, 206 is needed to compensate impairment of the signals based on the impairment phenomena.

After impairment pre-compensation, IFFT can be conducted to convert frequency-domain signal to time-domain signal (207 in FIG. 2) and an operation such as de-overlapping of the signal is performed at this stage. After obtaining the time-domain signal, the signal can be input into a Digital to Analog Converter (DAC), to be converted into analog signal for transmission. Δt this time, the digital signal processing at the transmitter side (Transmitter Digital Signal Processing, TX DSP) ends.

FIG. 3 shows a schematic flow diagram of digital signal processing at receiver during P2MP network's communication process. It can be understood that the receiver can be either an AP or a HUB. In some embodiments of the present disclosure, if the transmitter in FIG. 2 is HUB, the receiver in FIG. 3 is AP. If the transmitter in FIG. 2 is AP, the receiver in FIG. 3 is HUB. As shown in FIG. 3, after receiving the signal transmitted by the transmitter, the receiver can adjust the gain of the internal amplifier of the receiver according to the input signal by using an Automatic Gain Control (AGC) circuit in the receiver, and adjust the power of the received signal to an appropriate power.

If the signal received by the receiver is weak, the receiver can increase the gain and amplify the signal based on the AGC circuit. If the signal received by the receiver is strong, the receiver can reduce the gain and weaken the signal based on the AGC circuit to avoid overload of the circuit at the receiver.

It can be understood that when the power of the signal is adjusted by the automatic gain control circuit, 301 can be adopted first, in which the analog signal may be input to an Analog-to-Digital Converter (ADC). Thus, the analog signal is converted into the digital signal, and then the gain of the internal amplifier in the receiver is adjusted.

After the power of the signal is adjusted, FFT needs to be performed on the signal to convert the time-domain signal into the frequency-domain signal, and operations such as windowing and overlapping can be performed on the signal during FFT to prevent leakage of the frequency spectrum, and to prevent distortion of the amplitude of the signal when the signal is converted back to the time-domain signal through IFFT.

Then 303 needs to be conducted to compensate for the impairment in the frequency domain, whose principle is similar with that of 206 in FIG. 2 above, and will not be described here again. After impairment compensation is performed on the signal, the de-multiplexing operation is performed on the multiplexed signal. For example, the multiplexed signal can be input to a de-multiplexer (DeMux), and then the de-multiplexed signal will be acquired.

The signal applied to each sub-carrier should go through Chromatic Dispersion Compensation (CDC) operation (305) to compensate for the accumulated chromatic dispersion, caused by propagation in the optical fiber.

The compensated signal is then input to a Multiple-Input Multiple-Output Equalizer (MIMO EQ) to compensate for distortion of signal due to Polarization Mode Dispersion and Polarization Rotations during transmission of the signal.

After the above compensation operation, the signal applied to each sub-carrier is converted to the time-domain signal by IFFT operation (307 in FIG. 3) and the signal can also be de-overlapped during this process. Because problems such as phase noise and frequency offset may occur during transmission of the signal, it is generally necessary to perform the Carrier Recovery operation on the time-domain signal at the receiver side to compensate for the phase noise and the frequency offset.

Finally, 309 is conducted to demodulate the signal, and then the demodulated signal is input to the FEC decoder (310 in FIG. 3), so that the receiver can obtain accurate information represented by the signal applied to each sub-carrier. Δt this time, the digital signal processing at the receiver side (Receiver Digital Signal Processing, RX DSP) ends.

After the signal goes through all the steps shown in FIG. 3, the receiver can obtain the content represented by the signal on the sub-carrier.

It can be understood that sub-carriers in the P2MP network shown in FIG. 1 generally have both an active state and an inactive state during communication. HUB and AP can communicate with each other through active sub-carriers. That is to say, HUB can transmit signals to corresponding ΔP in the downlink through active sub-carriers, and ΔP can also transmit signals to HUB in the uplink through active sub-carriers. Similarly, if a sub-carrier is in the inactive state, HUB cannot communicate with ΔP through the sub-carrier in the inactive state. In some embodiments, the signal transmission processes (i.e., communication procedures) in the downlink and uplink can be performed simultaneously.

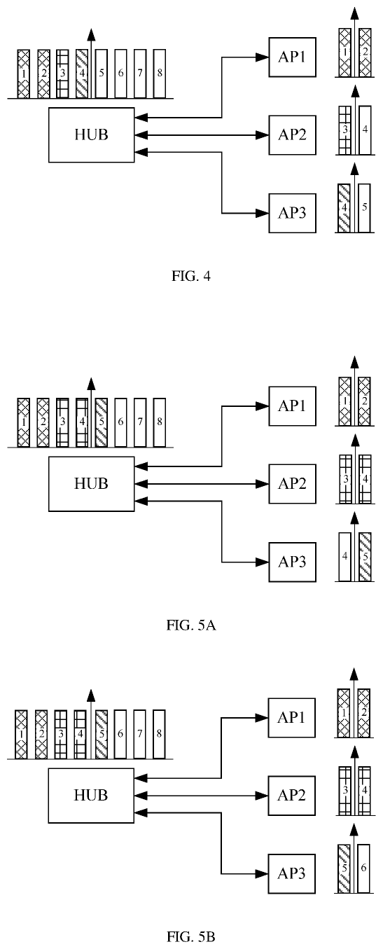

FIG. 4 shows a schematic diagram of an initial configuration of P2MP network and the state of sub-carriers. As shown in FIG. 4, the network includes four nodes, one HUB and three APs. HUB in FIG. 1 generates eight different sub-carriers, and each ΔP is assigned to two different sub-carriers generated by HUB. Specifically, AP1 is assigned to sub-carrier 1 and sub-carrier 2 generated by HUB, where sub-carrier 1 and sub-carrier 2 are both in the active state; AP2 is assigned to sub-carrier 3 and sub-carrier 4 generated by HUB, where sub-carrier 3 is in the active state and sub-carrier 4 is in the inactive state; AP3 is assigned to sub-carrier 4 and sub-carrier 5 generated by HUB, where sub-carrier 4 is in the active state and sub-carrier 5 is in the inactive state. Further, sub-carrier 6, sub-carrier 7, the sub-carrier 8 are not assigned, so they have no applied APs.

From FIG. 4, sub-carrier 4 is assigned to AP2 and AP3, respectively. Δt AP2 side, sub-carrier 4 is inactive, and at AP3 side, sub-carrier 4 is active. Thus, it can be understood that when one sub-carrier is assigned to a plurality of different APs, only one ΔP can communicate with HUB through the sub-carrier, so as to avoid signals interference caused by communication of a plurality of different APs with one HUB through the same sub-carrier.

For the network shown in FIG. 4, only sub-carrier 3 of the two sub-carriers assigned to AP2 can transmit signals, causing a waste of a frequency range occupied by sub-carrier 4, and further causing a reduced signal transmission capacity between AP2 and HUB. Since sub-carrier 4 cannot be used by AP2 for data transmission, AP2 can only transmit using sub-carrier 3, thus operating at half the target data throughput. On the other hand, if AP2 needs to upgrade the data rate and operates at the full baud rate (or equivalently, full target data throughput), sub carrier 4 needs to be activated for AP2 and turned off at AP3.

Therefore, based on the above technical problems, the present disclosure provides a communication method. In the method, when the first device and the second device in the P2MP network communicate with each other, if there is the first sub-carrier with inactive state between the two devices, the first sub-carrier is in active state between the second device and the third device, and there is a second sub-carrier with inactive state between the second device and the third device, then the state of the first sub-carrier between the first device and the second device is changed from inactive state to active state, so that the first device and the second device can transmit signals based on the first sub-carrier. And changing the state of the first sub-carrier between the first device and the second device from inactive state to active state, means that the second device and the third device cannot communicate based on the first sub-carrier. In this case, the second sub-carrier can be set to be active to transmit signals instead of the first sub-carrier between the second device and the third device (for example, copying the signal transmitted by the first sub-carrier between the second device and the third device into the second sub-carrier).

In this way, the first device and the second device can communicate with each other based on the first sub-carrier, avoiding the waste of the frequency range occupied by the first sub-carrier, and improving the signal transmission capacity between the first device and the second device. In addition, the second device can still communicate with the third device because the second sub-carrier between the second device and the third device has become active. The present disclosure improves the signal transmission capacity between the first device and the second device without affecting the communication between the second device and the third device, and increases the baud rate of the first device, realizing the hitless upgrade of P2MP network.

The network upgrade method provided in this disclosure will be described in detail on the basis of the network shown in FIG. 4. In FIG. 4, AP2 represents the first device above, HUB represents the second device, AP3 represents the third device, sub-carrier 4 represents the first sub-carrier, and sub-carrier 5 represents the second sub-carrier.

In some embodiments, when the state of sub-carrier 4 between AP2 and HUB is inactive, AP2 can send an upgrade request to HUB to change the state of sub-carrier 4 from inactive state to active state. After receiving the upgrade request sent by AP2, in the downlink direction, HUB copies the signal on sub-carrier 4 into sub-carrier 5, and then HUB can transmit signals to AP3 based on sub-carrier 5. Then, HUB stops sending signals to AP3 based on sub-carrier 4, which changes the state of sub-carrier 4 between HUB and AP3 to inactive state. And HUB starts sending signals to AP2 based on sub-carrier 4, which makes sub-carrier 4 between HUB and AP2 becomes active. In this way, HUB can send signals to AP2 based on sub-carrier 4, which can receive the signal on sub-carrier 4 sent by HUB.

In addition, after receiving the upgrade request sent by AP2, HUB also sends the upgrade instruction to AP3. After receiving the upgrade instruction, in the uplink direction, AP3 then copies the signal on sub-carrier 4 at the side of AP3 to sub-carrier 5. In this way, AP3 can send signals to HUB based on sub-carrier 5 and stop sending signals to HUB based on sub-carrier 4. After that, HUB sends the upgrade instruction to AP2. After receiving the upgrade instruction, AP3 then starts sending signals to HUB based on sub-carrier 4. Thus, AP2 can send signals to HUB based on sub-carrier 4, and HUB can also receive signals on sub-carrier 4 sent by AP2.

Δt this point, AP2's upgrade is completed. HUB and AP2 can communicate with each other through sub-carrier 4, who becomes active between HUB and AP2.

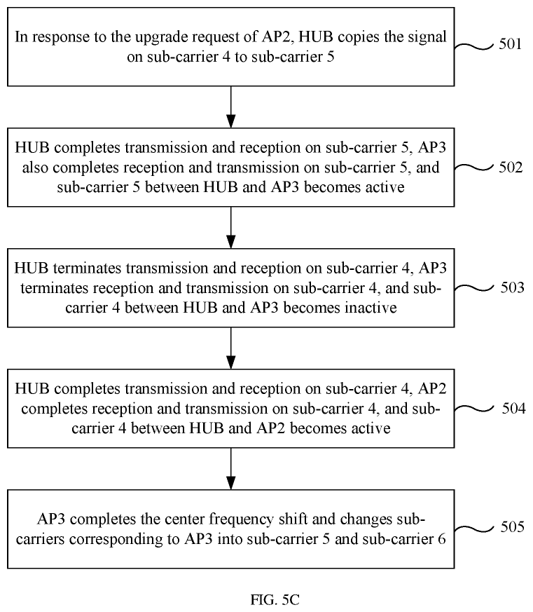

FIG. 5A shows a schematic diagram of a target configuration obtained by using the above method on the basis of the network configuration shown in FIG. 4. As shown in FIG. 5A, AP1 is assigned to sub-carrier 1 and sub-carrier 2, and the states of sub-carrier 1 and sub-carrier 2 are not changed. AP2 is still assigned to sub-carrier 3 and sub-carrier 4, but the state of sub-carrier 4 changes from inactive state to active state. AP3 is still assigned to sub-carrier 4 and sub-carrier 5, but the state of sub-carrier 4 changes from active state to inactive state, and the state of sub-carrier 5 changes from inactive state to active state.

In some embodiments of the present disclosure, ΔP is assigned to corresponding sub-carriers based on its center frequency. Taking AP1 in the network shown in FIG. 5A as an example, the center frequency of AP1 (or the frequency range in which AP1 is located) is the same as the center frequency of sub-carrier 1 and sub-carrier 2 (or the whole frequency range in which the sub-carrier 1 and sub-carrier 2 are located), so that AP1 can communicate with HUB through sub-carrier 1 and sub-carrier 2.

Therefore, in some embodiments, the method provided in the present disclosure may further prepare for the subsequent upgrade of AP3 by changing the (laser) center frequency of AP3 to change sub-carriers assigned to AP3 to active sub-carrier 5 and inactive sub-carrier 6 on the basis of the network shown in FIG. 5A. Thus, when AP3 in the network will be further upgraded, the state of sub-carrier 6 can be directly changed to active state, and then HUB may communicate with AP3 through sub-carrier 5 and sub-carrier 6, thereby further improving the communication capacity of the network.

The network obtained after the network upgrade in FIG. 5A based on the above can be referred to FIG. 5B, which shows another schematic diagram of a target configuration and a state of sub-carriers in P2MP network. Unlike FIG. 5A, in FIG. 5B, the sub-carriers applied to AP3 changes from inactive sub-carrier 4 to inactive sub-carrier 6. That is to say, AP3 in FIG. 5B corresponds to active sub-carrier 5 and inactive sub-carrier 6.

Before describing in detail the communication method for P2MP network in the present disclosure, the electronic devices (e.g. HUB, AP1, AP2, and AP3) to which the method can be applied are first introduced. It can be understood that the communication method provided in the embodiments of the present disclosure is applicable to any electronic device with a communication function, including but not limited to tablet computers, servers, and the like. What's more, the type and form of the electronic devices are not limited in the embodiments of the present disclosure.

It will be appreciated that in the embodiments of the present disclosure, HUB transmits a signal to ΔP based on a sub-carrier in the downlink direction, and may be expressed as HUB transmits the sub-carrier to AP; Similarly, ΔP transmits a signal to HUB based on a sub-carrier in the uplink direction, and may be expressed as that ΔP transmits the sub-carrier to HUB.

FIG. 5C shows a schematic diagram of upgrading the network configuration shown in FIG. 4, in which the first device is AP2, the second device is HUB, the third device is AP3, the first sub-carrier is sub-carrier 4, and the second sub-carrier is sub-carrier 5. As shown in FIG. 5C, the method includes following steps 501 to 505:

501: In response to the upgrade request of AP2, HUB copies the signal on sub-carrier 4 to sub-carrier 5.

In the embodiment of the present disclosure, HUB is considered to be the master node, and APs are considered as secondary node that sends request for upgrade to HUB. It also possible that HUB initiate upgrade process for an AP. Therefore, APs need to send the upgrade request to HUB in the uplink direction, and HUB needs to determine whether the upgrade starts or not.

When AP2 sends an upgrade request to HUB, it means that AP2 asks for change of AP2's state from an inactive state to an active state. In the downlink, HUB copies the signal on sub-carrier 4 to sub-carrier 5. Then HUB can transmit signal to AP3 based on sub-carrier 4 and sub-carrier 5.

502: HUB completes transmission and reception on sub-carrier 5, AP3 also completes reception and transmission on sub-carrier 5, and sub-carrier 5 between HUB and AP3 becomes active.

It can be understood that in the downlink, HUB transmits sub-carrier 4 and sub-carrier 5 to AP3, and sends an upgrade instruction to AP3 on sub-carriers 4 and sub-carrier 5, informing AP3 that the upgrade has started. After receiving the upgrade instruction, AP3 starts receiving sub-carrier 4 and sub-carrier 5 sent by HUB.

What's more, after receiving the upgrade instruction, AP3 also copies the signal on sub-carrier 4 to sub-carrier 5 at the AP3 side. Then in the uplink, AP3 transmits sub-carrier 4 and sub-carrier 5 to HUB, which starts receiving sub-carrier 4 and sub-carrier 5 sent by AP3.

After the above processes are completed, HUB cannot only transmit sub-carrier 5 to AP3, but receive sub-carrier 5 sent by AP3. Similarly, AP3 cannot only transmit sub-carrier 5 to HUB, but receive sub-carrier 5 sent by HUB. That is to say, HUB and AP3 can communicate with each other through sub-carrier 5, and the inactive sub-carrier 5 between HUB and AP3 is changed into the active sub-carrier 5.

503: HUB terminates transmission and reception on sub-carrier 4, AP3 terminates reception and transmission on sub-carrier 4, and sub-carrier 4 between HUB and AP3 becomes inactive.

In some embodiments, HUB sends an upgrade instruction to AP3, informing that the upgrade starts, and HUB neither transmits sub-carrier 4 to AP3, nor receives sub-carrier 4 sent by AP3. After AP3 receives the upgrade instruction, AP3 neither receives sub-carrier 4 sent by HUB, nor transmits sub-carrier 4 to HUB.

After the above processes are all completed, HUB no longer transmits and receives sub-carriers 4 to AP3; Similarly, AP3 no longer receives and transmits sub-carriers 4 to HUB. That is, HUB and AP3 no longer communicate through the sub-carrier 4, and the state of the sub-carrier 4 between HUB and AP3 becomes inactive.

504: HUB completes transmission and reception on sub-carrier 4, AP2 completes reception and transmission on sub-carrier 4, and sub-carrier 4 between HUB and AP2 becomes active.

It can be understood that in the downlink, HUB starts sending sub-carrier 4 to AP2, while HUB sends an upgrade instruction to AP2 based on sub-carrier 4, informing that the upgrade is started. After receiving the upgrade instruction, AP2 starts receiving sub-carrier 4.

In addition, after receiving the upgrade instruction, AP2 starts transmitting sub-carrier 4 to HUB in the uplink, and HUB starts receiving sub-carrier 4 transmitted by AP2.

After the above processes are completed, HUB may not only transmit sub-carrier 4 but receive sub-carrier 4. Similarly, AP2 may not only transmit sub-carrier 4 but receive sub-carrier 4. That is, HUB and AP2 may communicate with each other through sub-carrier 4, and sub-carrier 4 between HUB and AP2 becomes active.

505: AP3 completes the center frequency shift and changes sub-carriers applied to AP3 into sub-carrier 5 and sub-carrier 6.

It can be appreciated that, in present disclosure, each sub-carrier occupies a different frequency range, and therefore, AP3 can adjust the frequency spectrum by changing its laser center frequency, thereby changing sub-carriers applied to AP3. That is to say, by changing the center frequency, AP3 changes inactive sub-carrier 4 and active sub-carrier 5 applied to AP3 into active sub-carrier 5 and inactive sub-carrier 6. In this manner, the room may be set for subsequent upgrade of AP3. For example, when AP3 needs to be upgraded, the state of sub-carrier 6 may be directly changed from inactive state to active state.

During the upgrade process of AP2, the method neither affect the communication status of AP3 and HUB (for example, interrupting the communication between AP3 and HUB), nor does it affect the contents of the signals transmitted by AP3 and HUB. In addition, compared with the method in which HUB can communicate with AP2 only by sub-carrier 3, the method provided in the present disclosure enables HUB to communicate with AP2 on both sub-carrier 3 and sub-carrier 4. Therefore, the method provided in the present disclosure avoids the waste of the frequency range occupied by sub-carrier 4, improves the signal transmission capacity between AP2 and HUB without interrupting the communication process between AP3 and HUB, and increases the baud rate corresponding to AP2.

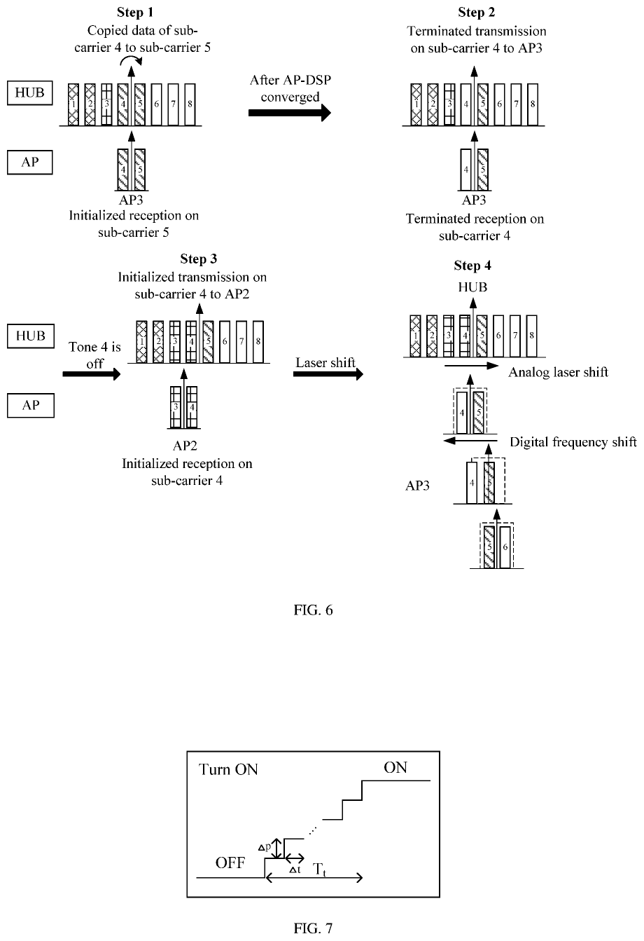

The above steps are explained in detail below through the downlink and uplink of the network respectively. FIG. 6 shows a schematic flow diagram of a communication method in the downlink. It can be understood that in the downlink, HUB is the transmitter and APs are the receivers. As shown in FIG. 6, the upgrade process of the network in the downlink side includes the following steps:

Step 1: In response to the upgrade request of AP2, HUB copies the signal on sub-carrier 4 to sub-carrier 5 and transmits sub-carrier 4 and sub-carrier 5 to AP3; AP3 initializes reception on sub-carrier 5 transmitted by HUB.

It can be understood that in the present embodiment, sub-carrier 5's transmission from HUB to AP3 means that HUB transmits signal to AP3 based on sub-carrier 5. Similarly, the reception on sub-carrier 5 by AP3 means that AP3 starts receiving the signal transmitted by HUB based on sub-carrier 5.

In some embodiments of the present disclosure, after HUB receives the upgrade request sent by AP2, it determines that the upgrade request is used to change the inactive sub-carrier 4 into an active one between HUB and AP2. And then, HUB can start the upgrade process. For example, HUB copies the signal on sub-carrier 4 to sub-carrier 5, and then transmits sub-carrier 4 and sub-carrier 5 to AP3. In addition, HUB can also inform AP3 that the update has been started through sub-carrier 4 and sub-carrier 5. When AP3 receives sub-carrier 4 and sub-carrier 5, it knows that the update has been started, and it will find out which sub-carrier has been updated (or has been turned on) according to sub-carrier's power level. When it finds out sub-carrier 5 has been turned on, it can start receiving sub-carrier 5.

The principle by which AP3 can find out that a sub-carrier has been turned on, according to the power level of the received sub-carriers, is as follows. In FIG. 4, sub-carrier 4 is active, sub-carrier 5 is inactive, and sub-carrier 5 cannot be used to transmit a signal. Therefore, the sub-carrier received by AP3 does not include sub-carrier 5. When the network needs to be upgraded, HUB can copy the signal on sub-carrier 4 to sub-carrier 5, so that sub-carrier 5 becomes active, and sub-carrier 5 can transmit a signal, and the signal transmitted by sub-carrier 5 is the same as the signal transmitted by sub-carrier 4. Δt this time, the sub-carriers received by AP3 include sub-carrier 5. As the number of sub-carriers received by AP3 increases, the power also increases.

Therefore, if the state of a sub-carrier changes, the power of the sub-carrier (that is, the power of the signal on the sub-carrier) changes. For example, if the state of a sub-carrier is changed from an active state to an inactive state, which means the sub-carrier is turned off, the power of the sub-carrier decreases because the sub-carrier cannot transmit signals. If the state of a sub-carrier is changed from an inactive state to an active state, which means the sub-carrier is turned on, the power of the sub-carrier increases because the sub-carrier can transmit signals. What's more, in general, there will be a sudden change of sub-carrier's power when the state of the sub-carrier changes.

That is, in this step, when HUB turns on sub-carrier 5 and transmits sub-carrier 5 to AP3, the power of sub-carrier 5 will suddenly increase.

As previously described, the signal power (or the power of sub-carriers) is tracked and adjusted by the automatic gain control (AGC) circuit after the receiver receives signals transmitted by sub-carriers. However, the AGC circuit at the receiver side can dynamically track signals when the power of the received signals changes slowly, and then adjust the gain. If the power of signals suddenly changes, the AGC circuit cannot dynamically track the power of signals and adaptively adjust the gain, thereby causing communication interruption between AP and HUB. Therefore, the change in the state of sub-carrier 5 may cause a sudden increase of its power, and the AGC circuit at the AP3 side may be unable to track the sub-carrier 5. Thus, the communication between AP3 and HUB may be interrupted.

To avoid this problem, in one embodiment, the power of sub-carrier 5 can be gradually changed when the state of sub-carrier 5 changes, so that AP3 can track the power change of sub-carrier 5 based on its AGC circuit. For example, when the state of sub-carrier 5 is changed from inactive state to active state (that is, sub-carrier 5 is turned on), as shown in FIG. 7, if the total duration of sub-carrier 5's state shift from the OFF state to the ON state is Tt and the total power increase is P, the total duration can be divided into n periods of time, and each period lasts for Δt. In this way, the power change of sub-carrier 5 can be controlled to increase by ΔP in each time period Δt. Therefore, the power of sub-carrier 5 is gradually increased during the initialization process of sub-carrier 5, thereby preventing the communication between AP3 and HUB from being interrupted.

In the embodiment of the present disclosure, the magnitude of Δt and ΔP in the initialization process of sub-carrier 5 are not limited. Illustratively, the magnitude of Δt and AP can be set empirically, or can be adjusted according to AGC's tracking capability, etc.

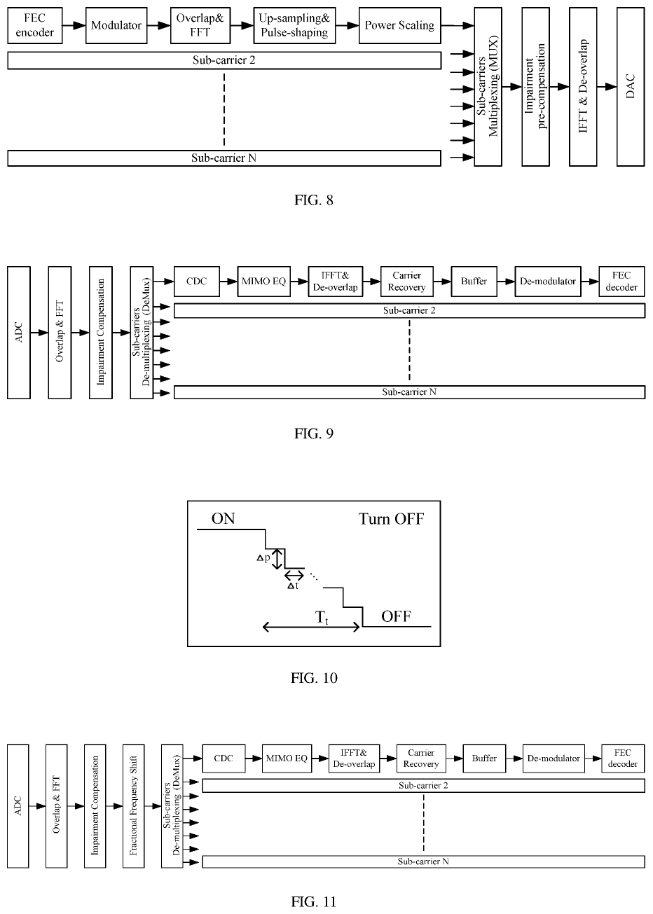

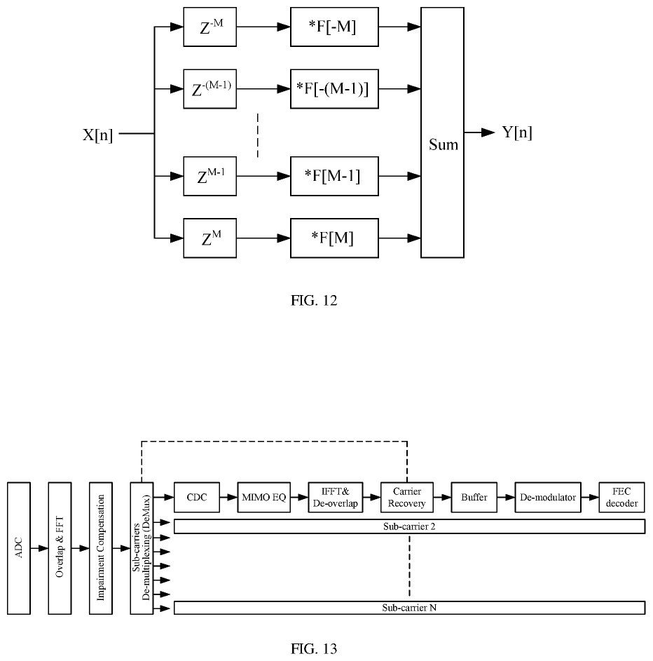

FIG. 8 shows a schematic flow diagram of digital signal processing including power scaling step at transmitter. As shown in FIG. 8, when changing the state of a sub-carrier, the transmitter can adjust the power change of the sub-carrier before multiplexing sub-carriers, so that the receiver can track the power change and receive the sub-carrier successfully. The sub-carriers are then subjected to subsequent operations such as FFT according to steps shown in FIG. 3.

It can be understood that it will take a period of time for the steps shown in FIG. 3 to be completed. When a sub-carrier goes through the digital signal processing (DSP) process shown in FIG. 3, the sub-carrier converges. It means that AP3 can acquire the contents of the signal on sub-carrier 4 and sub-carrier 5. And also, AP3 completes its initial reception on sub-carrier 5.

In addition, AP3 can also calculate the time delay (or time difference) between the signals on sub-carrier 4 and sub-carrier 5, in order to perform an alignment operation between sub-carrier 4 and sub-carrier 5 based on the time delay. By doing so, an out-of-synchronization problem of the signals on sub-carrier 4 and sub-carrier 5 can be avoided.

The calculation method of time delay between the signals on sub-carrier 4 and sub-carrier 5 is not limited in this embodiment of the present disclosure. For example, AP3 can calculate the generalized cross-correlation (GCC) function between the signals on sub-carrier 4 and sub-carrier 5, and then detect peak of the GCC function. The time corresponding to the peak is the time delay between the signals on sub-carrier 4 and sub-carrier 5 which can be eliminated by buffering the data. To this end, the pointer of sub-carrier 5 in buffer is aligned with the pointer of sub-carrier 4 based on the time delay, to eliminate the delay between sub-carrier 5 and sub-carrier 4.

FIG. 9 shows a schematic flow diagram of digital signal processing including sub-carrier alignment step at receiver. As shown in FIG. 9, the alignment step for sub-carriers can be added between the carrier recovery step and demodulation step, and the alignment can be implemented inside the buffer in the figure. That is, the pointer to the Start of Frame of sub-carrier 5 can be aligned with the pointer to the Start of Frame of sub-carrier 4 in the buffer.

In conclusion, in this step, HUB copies the signal of sub-carrier 4 to sub-carrier 5, changes the state of sub-carrier 5, and makes sub-carrier 5's power gradually increase, so that AP3 can successfully receive sub-carrier 4 and sub-carrier 5, thereby avoiding the communication interruption problem in the network's upgrade process. What's more, the alignment operation is also performed on sub-carrier 4 and sub-carrier 5 at AP3 side, synchronizing the signals on sub-carrier 4 and sub-carrier 5, and avoiding the out-of-synchronization problem of the signals on sub-carriers 4 and sub-carrier 5.

Step 2: HUB terminates transmission on sub-carrier 4 to AP3, and AP3 terminates reception on sub-carrier 4 transmitted by HUB.

After AP3 receives sub-carrier 5, and after sub-carrier 5 converges at the AP3 side, HUB no longer transmits signals to AP3 through sub-carrier 4. That is, HUB no longer transmits sub-carrier 4 to AP3, and HUB no longer receives sub-carrier 4 transmitted by AP3.

Similar to the principle in the previous step 1, HUB can also gradually change the power of sub-carrier 4 when HUB changes the state of sub-carrier 4, so that AP3 can track the power change of sub-carrier 4 based on the AGC circuit. By doing so, the problem that the AGC circuit cannot track sub-carrier 4's power change when HUB turns off sub-carrier 4 can be avoided.

For example, when the state of sub-carrier 4 is changed from active state to inactive state (that is, sub-carrier 4 is turned off), as shown in FIG. 10, if the total duration of the sub-carrier 4's state shift from the ON state to the OFF state is Tt and the total power change is P, the total duration can be divided into n periods of time, and each period lasts for Δt. In this way, the power reduction of sub-carrier 4 can be controlled to decrease by ΔP in each time period Δt. Therefore, the power of sub-carrier 4 is gradually decreased during the termination process of sub-carrier 4, thereby preventing the communication between AP3 and HUB from being interrupted.

In the embodiment of the present disclosure, the magnitude of Δt and ΔP in the termination process of sub-carrier 4 is not limited. Illustratively, the magnitude of Δt and ΔP can be set empirically, or can be adjusted according to AGC's tracking capability, etc.

After AP3 finds out that HUB has turned off sub-carrier 4 according to the power change of sub-carrier 4, AP3 will terminate reception on sub-carrier 4.

Thus, in the downlink between HUB and AP3, HUB no longer transmits sub-carrier 4 to AP3, and AP3 no longer receives sub-carrier 4 transmitted by HUB. HUB start transmitting sub-carrier 5 to AP3, and AP3 also start receiving sub-carrier 5 transmitted by HUB.

Step 3: HUB initiates transmission on sub-carrier 4 to AP2, and AP2 initiates reception on sub-carrier 4 transmitted by HUB.

After AP3 terminates reception on sub-carrier 4, HUB initiates transmission on sub-carrier 4 to AP2. Similar to the contents in step 1, when sub-carrier 4 is turned on, HUB gradually increases the power of sub-carrier 4 in the manner shown in FIG. 7, so that AP3 can track the power change of sub-carrier 4, and then can successfully receive sub-carrier 4. Then, AP3 starts the digital signal process on sub-carrier 4. After the process converges, AP3 can acquire the contents of the signal transmitted by sub-carrier 4.

Step 4: AP3 changes its laser center frequency, thus changing sub-carriers between AP3 and HUB from inactive sub-carrier 4 and active sub-carrier 5 to active sub-carrier 5 and inactive sub-carrier 6.

It can be understood that, as previously described, different sub-carriers occupy different frequency ranges, so AP3 can adjust its frequency spectrum by changing its laser center frequency, thus changing sub-carriers applied to AP3. For example, if the frequency range corresponding to sub-carrier 4 is A1-A2, the frequency range corresponding to sub-carrier 5 is A2-A3, and the frequency range corresponding to sub-carrier 6 is A3-A4, the frequency range corresponding to AP3 at the beginning is A1-A3, and the laser center frequency is A2. Therefore, in some embodiments, if the frequency range corresponding to AP3 is changed from A1-A3 to A2-A4, then the laser center frequency corresponding to AP3 can be changed from A2 to A3. The sub-carriers applied to AP3 can be changed from sub-carrier 4 and sub-carrier 5 to sub-carrier 5 and sub-carrier 6.

Further, in the situation where AP3 is applied to inactive sub-carrier 4 and active sub-carrier 5, HUB can only communicate with AP3 through sub-carrier 5. In the situation where sub-carriers applied to AP3 are changed to sub-carrier 5 and sub-carrier 6, HUB still communicates with AP3 through sub-carrier 5. Therefore, the change in the laser center frequency of AP3 does not affect the normal communication between HUB and AP3. That is to say, HUB is blind to AP3's center frequency shift process.

As shown in step 4 of FIG. 6, the shift of AP3's center frequency includes the shift in digital part and the shift in analog part. In the analog part, the analog frequency is changed by controlling the center frequency of the laser. Δt the same time, the digital frequency shift can be used to compensate for the analog frequency shift. That is to say, it is necessary to synchronize analog frequency shift with digital frequency shift of AP3. Note that if the shift of the analog frequency and the digital frequency are not synchronized, for example, the analog frequency shift lags behind the digital frequency shift in DSP, a residual frequency offset may occur, and its value may be too big to track at the AP3 side, resulting in the problem that the shifted laser center frequency corresponding to AP3 cannot be accurately determined.

In some embodiments, center frequency can be shifted by a pre-determined frequency step using laser control in analog part. The value of the frequency step is not limited in the embodiment of the present disclosure. For example, the value of the frequency step can be set empirically, or can be flexibly adjusted according to the frequency range corresponding to sub-carriers.

In some embodiments, it is generally necessary to compensate for the integer part and the fractional part of the frequency step respectively when compensating for the frequency step in the digital part. Based on this, the compensation methods for the frequency step in the digital part include, but are not limited to, the following two types:

Type 1: The fractional part of the frequency step is compensated by means of fractional digital frequency shift, and the integer part of the frequency step is compensated in de-multiplexer (DeMux) at the receiver side.

FIG. 11 shows a schematic diagram of a digital signal processing including fractional digital frequency shift step at the receiver side. As shown in FIG. 11, the fractional digital frequency shift step can be added between the impairment compensation step and sub-carriers de-multiplexing step. After the impairments in the digital received signal is compensated, the AP3 side can conduct fractional digital frequency shift on the signal to compensate for the fractional part of the frequency step. And then the output signal is sent to the de-multiplexer to go through de-multiplexing operation, and the integer part of the frequency step can also be compensated for during this stage. Thus, the center frequency corresponding to AP3 has changed from A2 to A3. That is to say, AP3 can be assigned to sub-carrier 5 and sub-carrier 6 after above method, and the update of AP3 is completed.

In the structure shown in FIG. 11, the analog frequency step has been compensated before de-multiplexing and all per-sub-carrier modules including CDC, MIMO and the like. That is to say, these modules are blind to the frequency shift, so these modules will not be affected by above frequency shift step.

In some embodiments, the fractional digital frequency shift can be achieved based on a filter. The taps of the filter are not limited in the embodiments of the present disclosure, and the taps can be set empirically or can be flexibly adjusted according to actual application scenario. For example, the number of taps of the filter can be set to 2M+1 taps. It can be understood that the greater the M, the better the compensation, and the higher the complexity of the filter.

In the embodiment of the present disclosure, the output equation of the filter with 2M+1 taps can be referred to the following equation 1:

$$Y [ n ] = {\sum }_{k = - M}^{M} X [ n - k ] F [ k ] \qquad equation ( 1 )$$

In the above formula, Y [n] represents output signal; k represents the taps of the filter, and the value range of k is [−M, M], that is to say, the taps of the filter is 2M+1; F [k] represents coefficients of the filter, and the coefficients of the filter are related to the taps of the filter; X [n] represents input signal, and X [n−k] represents the signal obtained by translating k frequency bins on the basis of X [n] where X [n] is the FFT of the digital received signal; and z ( ) represents frequency delay.

In view of the above, in the case where the frequency step is known, above method can be used to compensate for the fractional part of the frequency step by adjusting the filter's taps, coefficients, and the like.

In this way, the AP3 signal frequency locations with respect to HUB appear unchanged. This process is repeated till AP3's active sub-carrier 5 is again to the left of AP3's center frequency. Thus, it is possible to upgrade AP3 by using sub-carrier 6 from HUB.

Type 2: The carrier recovery module and the de-multiplexer can be used to compensate for the frequency step on the receiver side.

As shown in FIG. 13, based on the de-multiplexer, compensation of the integer part of the frequency step is completed during de-multiplexing step of the signal. Then after the signal is assigned to the corresponding sub-carrier, the fractional part of the frequency step is compensated by the carrier recovery module.

For example, after the integer part of the frequency step is compensated during de-multiplexing step of the signal, the carrier recovery module can detect the difference (frequency offset) between the frequency variation in the analog part and the frequency variation in the digital part, and then compensate for this frequency offset, aligning frequency variation in the analog part and in the digital part.

The compensation method of the fractional part of frequency step on the basis of carrier recovery is not limited in the embodiment of the present disclosure.

In this step, the method of fractional digital frequency shift has been removed, which significantly reduces the complexity. AP3's laser center frequency has been changed based on the analog and digital part, changing sub-carriers applied to AP3 from sub-carrier 4 and sub-carrier 5 to sub-carrier 5 and sub-carrier 6. What's more, this process does not affect the communication process between HUB and AP3, preparing for AP3's upgrade in the future.

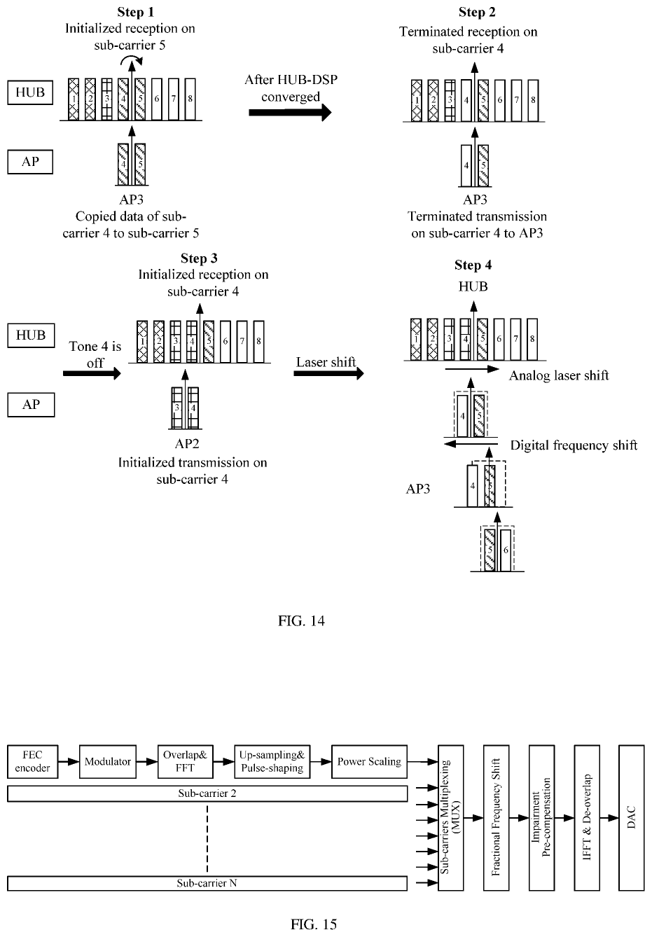

FIG. 14 shows a schematic flow diagram of a communication method in the uplink. It can be understood that in the uplink, ΔP is the transmitter and HUB is the receiver. As shown in FIG. 14, the upgrade process of the network in the uplink side includes the following steps:

Step 1: AP3 copies the signal on sub-carrier 4 to sub-carrier 5 and transmits sub-carrier 4 and sub-carrier 5 to HUB. HUB initializes reception on sub-carrier 5 transmitted by AP3.

When the network needs to be upgraded, AP3 can copy the signal on sub-carrier 4 to sub-carrier 5, so signals transmitted by sub-carrier 5 and sub-carrier 4 are the same. In addition, AP3 can also transmit sub-carrier 5 to HUB.

As in the previous step 1 in the downlink, when AP3 initializes sub-carrier 5 in the uplink, the power of sub-carrier 5 is gradually increased in the manner shown in FIG. 7, so that HUB can track the power change of sub-carrier 5, and successfully receive sub-carrier 5. HUB then performs digital signal processing on sub-carrier 5. And after the processing converges, HUB can acquire the contents of the signal transmitted by sub-carrier 5.

Step 2: AP3 terminates transmission on sub-carrier 4 to HUB, and HUB terminates reception on sub-carrier 4 transmitted by AP3.

After sub-carrier 5 converges at the HUB side, AP3 no longer transmits sub-carrier 4 to HUB, and HUB also needs to terminate reception on sub-carrier 4 transmitted by AP3.

Thus, in the uplink between AP3 and HUB, AP3 no longer transmits sub-carrier 4 to HUB, and HUB no longer receives sub-carrier 4 transmitted by AP3. AP3 can transmit sub-carrier 5 to HUB, and HUB can also receive sub-carrier 5 transmitted by AP3.

Step 3: AP2 initiates transmission on sub-carrier 4 to HUB, and HUB initiates reception on sub-carrier 4 transmitted by AP3.

After AP3 terminates transmission on sub-carrier 4 to HUB, AP2 initiates transmission on sub-carrier 4 to HUB. In a similar fashion, when AP2 turns on sub-carrier 4, the power of sub-carrier 4 is gradually increased in the manner shown in FIG. 7, so that HUB can track the change of the power of sub-carrier 4, and the sub-carrier 4 can be successfully received. HUB then performs digital signal processing on sub-carrier 4 transmission. After the processing converges, HUB can acquire the contents of the signal transmitted by sub-carrier 4.

Step 4: AP3 changes its laser center frequency, thus changing sub-carriers between AP3 and HUB from inactive sub-carrier 4 and active sub-carrier 5 to active sub-carrier 5 and inactive sub-carrier 6.

Similar to the method in previous step 4 in the downlink, the analog frequency shift can be achieved by a pre-determined frequency step change, and then the fractional digital frequency shift is used in the digital part to compensate the analog frequency shift, to achieve the laser center frequency shift of AP3. FIG. 15 shows a schematic flow diagram of digital signal processing including fractional digital frequency shift step at transmitter. As shown in FIG. 15, the fractional digital frequency shift step can be added between the impairment compensation step and the multiplexing step. The manner of compensating the analog frequency shift based on the fractional digital frequency shift in this step is similar to that in step 4, so the details are not described herein.

It should be noted that the upgrade in the downlink and the uplink shown in FIG. 6 and FIG. 14 are conducted simultaneously. Taking step 1 in downlink and uplink as an example, after both steps are completed, HUB not only transmits sub-carrier 5 to AP3, but also receives sub-carrier 5 transmitted by AP3. Similarly, AP3 not only transmits sub-carrier 5 to HUB, but also receives sub-carrier 5 transmitted by HUB. Thus, HUB and AP3 can communicate with each other through sub-carrier 5, and the state of sub-carrier 5 between HUB and AP3 is changed from the inactive state to the active state.

In the above content, the sequence of steps requires communication between HUB and APs. For example, in step 2, HUB terminates transmission on sub-carrier 4 to AP3 after sub-carrier 5 at the AP3 side has converged. Actually, after sub-carrier 5 at the AP3 side has converged, AP3 sends a message to HUB for informing that the convergence of sub-carrier 5's digital signal processing has been completed. And then, HUB terminates transmission on sub-carrier 4 to AP3. Therefore, in some embodiments, HUB and APs should communicate with each other by preset codes to acquire the latest state of each other, and then conducts the following steps.

In some embodiments, HUB and APs can acquire the current state of each other by codes included in the data frame corresponding to the sub-carrier. It can be understood that a data frame is a segment of data on an optical network which generally consists a frame header with training sequence, pilots and data payload. In the present disclosure, N bits in the header of the frame of each sub-carrier has been considered for representing codes.

The correspondence between the type of codes and the state of sub-carriers is shown in Table 1 below.

TABLE 1

| Code | AP | HUB |
|---|---|---|
| AA | Idle case | Idle case |
| BB | Acknowledge | Acknowledge |
| CC | Request for update | Update (Turn ON/OFF sub- |
| | | carriers) |
| DD | Request for no change and | Request for laser shift |
| | vice versa | |

As shown in Table 1, ΔP sends code AA to HUB, indicating that ΔP is currently in the idle state. Similarly, HUB sends code AA to AP, indicating that HUB is currently in the idle state. AP sends code BB to HUB, indicating that ΔP is currently in an acknowledgement state. Similarly, HUB sends code BB to AP, indicating that HUB is currently in an acknowledgement state. ΔP sends code CC to HUB, indicating that ΔP is currently asking for an update. Similarly, HUB sends code CC to AP, indicating that the update begins, which means that HUB has turned on or turned off corresponding sub-carriers. ΔP sends code DD to HUB, indicating that AP requests for no change. HUB sends code DD to AP, indicating that HUB requests ΔP to conduct laser frequency shift. It should be understood that the codes in Table 1 are example codes, just for explanation. In a real network, there may exist more codes corresponding to other network related functions or network monitoring.

In the network to which the present disclosure relates, HUB is considered to be the master node which manages the update, and APs are considered as the secondary nodes that can send request for the upgrade to HUB. Therefore, AP2 needs to send the upgrade request to HUB, and HUB needs to determine whether the update can be started or not. However, it is still possible that the HUB sends an update request to an ΔP in response to a network management request or the like.

Still taking the network configuration shown in FIG. 4 as an example, the following content describes in detail the communication process based on the above-mentioned codes between APs and HUB in the network's upgrade process. The communication process of APs and HUB can be referred to the following step S1 to step S5, which are not shown in the drawings.

S1: AP2 asks for capacity upgrade to HUB.

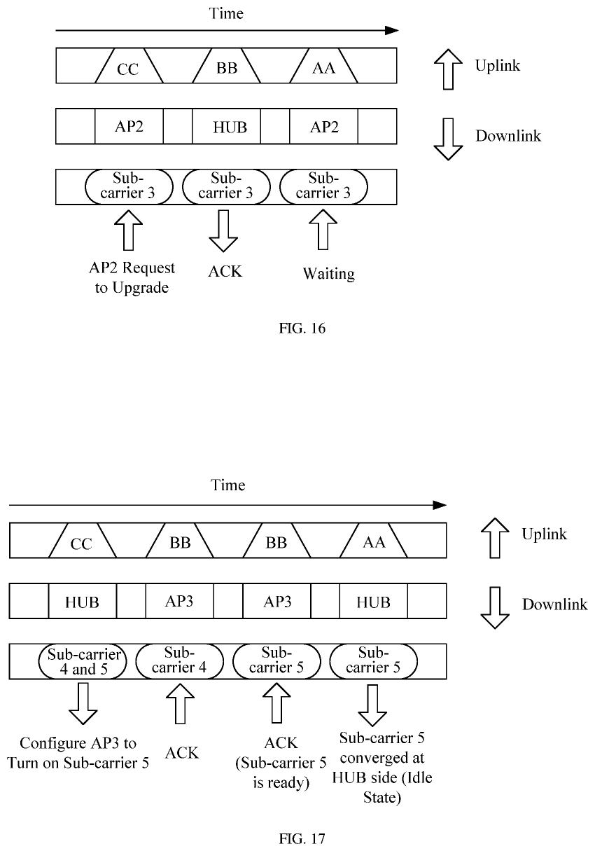

FIG. 16 shows a schematic diagram of a communication process between AP2 and HUB in the case of capacity upgrade request. As shown in FIG. 16, when AP2 needs to upgrade sub-carrier 4 from inactive state to active state, AP2 transmits code CC on active sub-carrier 3 to HUB in the uplink.

After HUB receives CC sent by AP2 and determines that the upgrade process can be performed, HUB sends BB to AP2 on active sub-carrier 3 in the downlink as an acknowledgement. In addition, HUB starts the upgrade operation. After receiving BB transmitted by HUB, AP2 knows that HUB has received the request for capacity upgrade, changes its switches to its idle state, and transmits AA to HUB on active sub-carrier 3 in the uplink. After receiving AA, HUB can determine that AP2 has received the acknowledge information sent by HUB and it is waiting for upgrade.

S2: HUB and AP3 complete transmission and reception on sub-carrier 5 respectively.

FIG. 17 shows a schematic diagram of communication process between AP3 and HUB during AP3's upgrade process. As shown in FIG. 17, after HUB determines that the upgrade process can be performed, the signal on sub-carrier 4 is copied into sub-carrier 5, and the code CC is transmitted to AP3 on sub-carrier 4 and sub-carrier 5 for informing that AP3's update has started. After receiving CC, AP3 determines which sub-carrier has been turned on by detecting the increase in the power of sub-carriers. When it finds out that sub-carrier 5 has been turned on by HUB, it will initialize the reception on sub-carrier 5, which means that a digital signal processing on sub-carrier 5 is conducted. What's more, after AP3 finds out that sub-carrier 5 has been turned on, AP3 can transmit BB to HUB on active sub-carrier 4. When HUB receives BB, it knows that AP3 has found out the updated sub-carrier.

After the digital signal processing on sub-carrier 5 at the AP3 side converges, AP3 transmits BB to HUB on sub-carrier 5 for informing that AP3 has completed reception on sub-carrier 5. And then AP3 switches to an idle state.

Further, after AP3 receives CC, it will also copy the signal on sub-carrier 4 at the AP3 side into sub-carrier 5, and transmit sub-carrier 4 as well as sub-carrier 5 to HUB. HUB can then receive sub-carrier 4 and sub-carrier 5 transmitted by AP3. Note that the method of HUB's reception on sub-carrier 4 and sub-carrier 5 is similar to that of AP3's reception on sub-carrier 5 mentioned above.

After receiving BB transmitted by AP3, HUB determines whether sub-carrier 5 at the HUB side transmitted by AP3 converges. If sub-carrier 5 at the HUB side has also converged, HUB transmits AA to AP3 on sub-carrier 5. After AP3 receives AA, it knows that sub-carrier 5 at the HUB side has already been received, and switches to the idle state. Δt this time, HUB and AP3 are both in idle states.

Thus, by copying the signal on sub-carrier 4 to sub-carrier 5, HUB can transmit sub-carrier 5 to AP3, and AP3 can also receive sub-carrier 5 transmitted by HUB. Further, by copying the signal on sub-carrier 4 to sub-carrier 5, AP3 can transmit sub-carrier 5 to HUB, and HUB can also receive sub-carrier 5 transmitted by AP3. That is to say, both HUB and AP3 complete transmission and reception on sub-carriers 5. HUB and AP3 can subsequently communicate with each other based on sub-carriers 5. The state of sub-carriers 5 between HUB and AP3 is changed from inactive state to active state.

S3: HUB and AP3 terminate transmission and reception on sub-carrier 4 respectively.

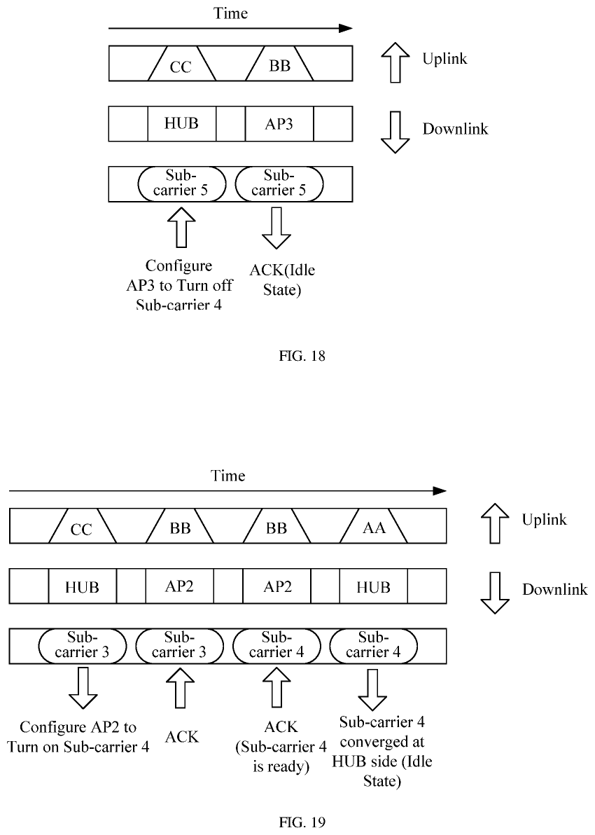

FIG. 18 shows a schematic diagram of a process in which HUB and AP3 no longer communicate with each other based on sub-carrier 4. As shown in FIG. 18, HUB can send an upgrade instruction to AP3 on sub-carrier 5 to determine the next upgrade step after HUB and AP3 can communicate through sub-carrier 5. For example, HUB sends CC to AP3 on sub-carrier 5 for informing AP3 that update has started. Meanwhile, HUB terminates transmission on sub-carrier 4 to AP3, and terminates reception on sub-carrier 4 transmitted by AP3. After receiving CC, AP3 finds out that sub-carrier 4 has been turned off by HUB through detecting a decrease in the power of sub-carrier 4. And then, AP3 stops receiving sub-carrier 4, and also stops transmitting sub-carrier 4 to HUB. Meanwhile, AP3 transmits BB to HUB on sub-carrier 5. When HUB receives BB, it knows that AP3 has found the sub-carrier which has been turned off.

Thus, HUB neither transmits sub-carrier 4 to AP3, nor receives sub-carrier 4 transmitted by AP3. AP3 neither transmits sub-carrier 4 to HUB, nor receives sub-carrier 4 transmitted by HUB. That is to say, HUB and AP3 no longer communicate with each other based on sub-carrier 4, and the state of sub-carrier 4 between HUB and AP3 is changed from active state to inactive state.

S4: HUB and AP2 complete transmission and reception on sub-carrier 4 respectively.

FIG. 19 shows a schematic diagram of communication process between AP2 and HUB during AP2's upgrade process. As shown in FIG. 19, after HUB and AP3 can no longer communicate with each other based on sub-carrier 4, HUB sends an upgrade instruction to AP2 to determine that the next upgrade step can be performed. For example, HUB transmits the code CC to AP2 on sub-carrier 3, informing that AP2's update has started. Meanwhile, HUB starts transmitting sub-carrier 4 to AP2. After receiving BB, AP2 finds out that sub-carrier 4 has been turned on by HUB through detecting an increase in the power of sub-carrier 4. And then, AP2 will initialize the reception on sub-carrier 4, which means that a digital signal processing on sub-carrier 4 is conducted.

What's more, after AP2 finds out that sub-carrier 4 has been turned on, AP2 can transmit BB to HUB on active sub-carrier 4. When HUB receives BB, it knows that AP2 has found out the updated sub-carrier. After the digital signal processing on sub-carrier 4 at the AP2 side converges, AP2 transmits BB to HUB on sub-carrier 4 for informing that AP2 has completed reception on sub-carrier 4.

In addition, after AP2 receives BB and finds out that sub-carrier 4 has been turned on, AP2 also starts transmitting sub-carrier 4 to HUB, which starts receiving sub-carrier 4.

After receiving BB transmitted by AP2, HUB determines whether sub-carrier 4 at the HUB side transmitted by AP2 converges. If sub-carrier 4 at the HUB side has also converged, HUB transmits AA to AP2 on sub-carrier 4. After AP2 receives AA, it knows that sub-carrier 4 at the HUB side has already been received, and switches to the idle state. Δt this time, HUB and AP3 are both in idle states.

Thus, HUB can transmit sub-carrier 4 to AP2, and AP2 can also receive sub-carrier 4 transmitted by HUB; In addition, AP2 can transmit sub-carrier 4 to HUB, and HUB can also receive sub-carrier 4 transmitted by AP2. That is to say, both HUB and AP2 complete transmission and reception on sub-carrier 4. HUB and AP2 can subsequently communicate with each other based on sub-carrier 4. The state of sub-carrier 4 between HUB and AP2 is changed from inactive state to active state.

S5: HUB sends an instruction on laser center frequency shift to AP3, and AP3 completes its center frequency shift.

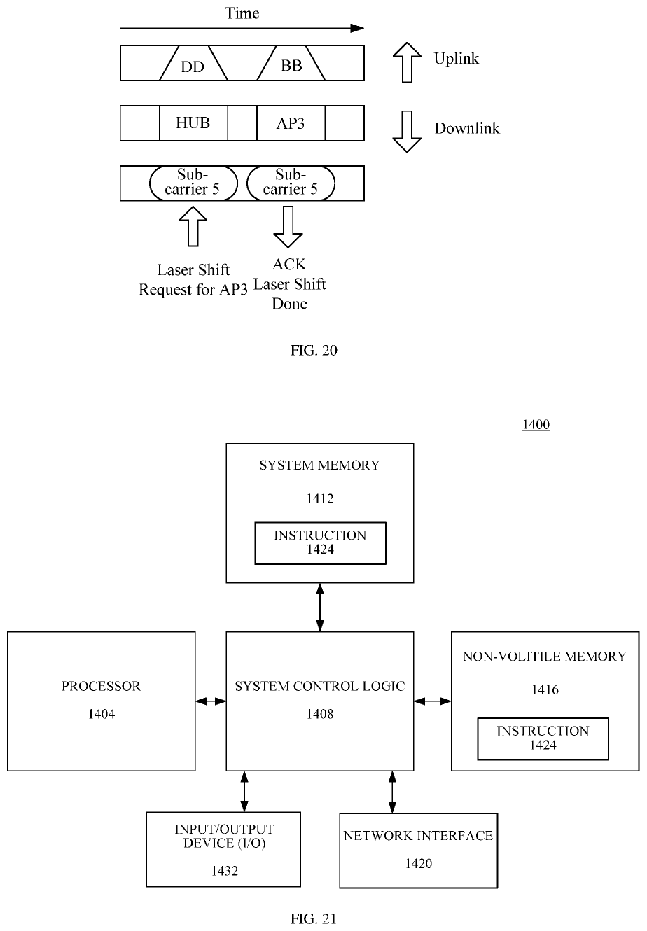

FIG. 20 shows a schematic diagram of a communication process between AP3 and HUB during AP3's center frequency shift process. As shown in FIG. 20, after HUB and AP2 can communicate with each other based on sub-carrier 4, HUB can transmit the code DD to AP3 on sub-carrier 5 for informing that the frequency shift can get started. After receiving DD transmitted by HUB, AP3 starts the process of laser center frequency shift, and changes sub-carriers at the AP3 side from inactive sub-carrier 4 and active sub-carrier 5 to active sub-carrier 5 and inactive sub-carrier 6.

After the frequency shift process, AP3 transmits BB to HUB on active sub-carrier 5, informing HUB that the frequency shift has been completed, and then sets its state to the idle state. After receiving BB sent by AP3, HUB also sets its state to the idle state. And now, HUB and AP3 are both in idle states.

Δt this time, the upgrade of the entire P2MP network is completed.

The communication method provided in the embodiments of the present disclosure, can control communication processes such as beginning of process and termination of process between APs and HUB by setting codes, improving the communication efficiency between APs and HUB. In addition, the method avoids the waste of the frequency range occupied by sub-carrier 4, improves the signal transmission capacity between AP2 and HUB without interrupting the communication process between AP3 and HUB, and also increases the baud rate corresponding to AP2, thereby realizing the non-interruption upgrade of the network. By changing the laser center frequency corresponding to AP3, sub-carriers applied to AP3 are changed into sub-carrier 5 and sub-carrier 6, so as to prepare for the subsequent upgrade of AP3.

What's more, embodiments of the disclosure provide a first device (HUB), which is used to perform the steps involved in above embodiments conducted by HUB.

Embodiments of the disclosure provide a second device (AP2), which is used to perform the steps involved in above embodiments conducted by AP2.

Embodiments of the disclosure also provide a third device (AP3), which is used to perform the steps involved in above embodiments conducted by AP3.

FIG. 21 shows a schematic structural diagram of an electronic device 1400 according to an embodiment of the present disclosure. In one embodiment, the system 1400 may include one or more processors 1404, system control logic 1408 coupled to at least one of the processors 1404, system memory 1412 coupled to the system control logic 1408, non-volatile memory (NVM) 1416 coupled to the system control logic 1408, and a network interface 1420 coupled to the system control logic 1408.

In some embodiments, the processors 1404 may include one or more single-core or multi-core processors. In some embodiments, the processors 1404 may include any combination of general-purpose processors and special purpose processors (e.g., graphics processors, disclosure processors, baseband processors, etc.). In embodiments where the system 1400 employs an eNB (Evolved Node B) 101 or a RAN (Radio Access Network) controller 102, the processors 1404 may be configured to perform various compliant embodiments, such as one or more of the various embodiments shown in FIGS. 5C, 6 and 14.

In some embodiments, the system control logic 1408 may include any suitable interface controller to provide any suitable interface to at least one suitable device or component of the processors 1404 that may communicate with the system control logic 1408.

In some embodiments, the system control logic 1408 may include one or more memory controllers to provide interfaces to the system memory 1412. The system memory 1412 may be used to load and store data and/or instructions. The memory 1412 of system 1400 may include any suitable volatile memory, such as a suitable dynamic random-access memory (DRAM), in some embodiments.

The NVM/memory 1416 may include one or more tangible, non-transitory computer-readable media for storing data and/or instructions. In some embodiments, the NVM/memory 1416 may include any suitable non-volatile memory, such as flash memory, and/or any suitable non-volatile storage device, such as at least one of an HDD (Hard Disk Drive), a CD (Compact Disc) drive, and a DVD (Digital Versatile Disc) drive.

The NVM/memory 1416 may include a portion of storage resources on the device on which the system 1400 is installed, or it may be accessed by, but not necessarily part of, the device. For example, the NVM/storage 1416 may be accessed over the network via the network interface 1420.

In particular, the system memory 1412 and NVM/memory 1416 may include a temporary copy and a permanent copy of instruction 1424, respectively. The instructions 1424 may include instructions that, when executed by at least one of the processors 1404, cause the system 1400 to implement the method shown in FIG. 5C. In some embodiments, instructions 1424, hardware, firmware, and/or software components thereof may additionally/alternatively be placed in system control logic 1408, network interface 1420, and/or processors 1404.

The network interface 1420 may include a transceiver for providing a radio interface for system 1400 to communicate with any other suitable device (e.g., front-end module, antenna, etc.) via one or more networks. In some embodiments, the network interface 1420 may be integrated with other components of system 1400. For example, the network interface 1420 may be integrated with at least one of the followings: a system memory 1412, a NVM/memory 1416, and a firmware device (not shown). When the instructions are executed by at least one of the processors 1404, the system 1400 can realize the method shown in FIG. 5C.

The network interface 1420 may further include any suitable hardware and/or firmware to provide a multiple-input multiple-output radio interface. For example, the network interface 1420 may be a network adapter, a wireless network adapter, a telephone modem, and/or a wireless modem.

In one embodiment, at least one of the processors 1404 may be packaged together with logic for one or more controllers of the system control logic 1408 to form a system SiP. In one embodiment, at least one of the processors 1404 may be integrated on the same die with logic for one or more controllers of the system control logic 1408 to form a system-on-chip (SoC).

The system 1400 may further include an input/output (I/O) device 1432. The I/O device 1432 may include a user interface to enable a user to interact with the system 1400. The peripheral component interface is designed so that the peripheral component can also interact with the system 1400. In some embodiments, the system 1400 further includes a sensor for determining at least one of environmental conditions and location information associated with the system 1400.

In some embodiments, the user interface may include, but is not limited to, a display (e.g., a liquid crystal display, a touch screen display, etc.), a speaker, a microphone, one or more cameras (e.g., still image cameras and/or cameras), a flashlight (e.g., a light emitting diode flash), and a keyboard.

In some embodiments, peripheral component interfaces may include, but are not limited to, non-volatile memory ports, audio jacks, and power interfaces.

In some embodiments, the sensors may include, but are not limited to, gyroscope sensors, accelerometers, proximity sensors, ambient light sensors, and positioning units. The positioning unit may also be part of or interact with the network interface 1420 to communicate with components of the positioning network (e.g., a Global Positioning System (GPS) satellite).

As used herein, the term “module” may refer to or include, an application specific integrated circuit (ASIC), an electronic circuit, a processor (shared, dedicated, or group) and/or memory that executes one or more software or firmware programs, a combinational logic circuit, and/or other suitable hardware components that provides the described functionality. What's more, the term “module” may also be part of these hardware components.

It will be appreciated that in various embodiments of the present disclosure, the processor may be a microprocessor, a digital signal processor, a microcontroller, or the like, and/or any combination thereof. According to another aspect, the processor may be a single-core processor, a multi-core processor, or the like, and/or any combination thereof.

The embodiments disclosed herein may be implemented in hardware, software, firmware, or a combination of these implementations. Embodiments of the present disclosure may be implemented as a computer program or program code executing on a programmable system including at least one processor, a storage system (including volatile and non-volatile memory and/or storage elements), at least one input device, and at least one output device.

Program code may be applied to the input instructions to perform the functions described herein and to generate output information. The output information may be applied to one or more output devices in a known manner. For purposes of this disclosure, a processing system includes any system with a processor such as, a digital signal processor (DSP), a microcontroller, an application specific integrated circuit (ASIC), or a microprocessor.

The program code may be implemented in a high-level programming language or an object-oriented programming language to communicate with the processing system. The program code may also be implemented in assembly language or machine language, if desired. Indeed, the mechanisms described herein are not limited in scope to any particular programming language. In either case, the language may be a compilation language or an interpretation language.

In some cases, the disclosed embodiments may be implemented in hardware, firmware, software, or any combination thereof. The disclosed embodiments may also be implemented as instructions carried by or stored on one or more temporary or non-temporary machine-readable (e.g., computer-readable) storage media, which may be read and executed by one or more processors. For example, the instructions may be distributed through a network or through other computer-readable media. Thus, a machine-readable medium may include any mechanism for storing or transmitting information in a form readable by a machine (e.g., a computer), including, but not limited to, a floppy disk, an optical disk, an optical disk, a read-only memory (CD-ROMs), a magneto-optical disk, a read-only memory (ROM), a random access memory (RAM), an erasable programmable read-only memory (EPROM), an electrically erasable programmable read-only memory (EEPROM), a magnetic or optical card, a flash memory, or a tangible machine-readable memory for transmitting information (e.g., a carrier wave, an infrared signal, a digital signal, etc.) in an electrical, optical, acoustic, or other form of propagated signal using the Internet. Thus, a machine-readable medium includes any type of machine-readable medium suitable for storing or transmitting electronic instructions or information in a form readable by a machine (e.g., a computer).

In the drawings, some structural or methodological features may be shown in a particular arrangement and/or sequence. However, it should be understood that such a particular arrangement and/or ordering may not be required. Rather, in some embodiments, these features may be arranged in a manner and/or sequence different from that shown in the illustrative drawings. In addition, the inclusion of structural or methodical features in a particular figure is not meant to imply that such features are required in all embodiments. And in some embodiments, such features may not be included or may be combined with other features.

It should be noted that each unit/module mentioned in each device embodiment of the present disclosure is a logical unit/module. Physically, a logical unit/module may be a physical unit/module, may be a part of a physical unit/module, or may be implemented in a combination of a plurality of physical units/modules. The physical implementation of these logical units/modules is not the most important. The combination of functions implemented by these logical units/modules is the key to solving the technical problem proposed in the present disclosure. Furthermore, in order to highlight the inventive part of the present disclosure, the above-mentioned device embodiments of the present disclosure do not introduce units/modules which are not closely related to solving the technical problems set forth in the present disclosure, which does not indicate that the above-mentioned device embodiments do not have other units/modules.

It is to be noted that in the examples and description of this disclosure, relational terms such as first and second etc. are used solely to distinguish one entity or operation from another entity or operation, and do not necessarily require or imply any such actual relationship or order between such entities or operations. Moreover, the terms “comprises”, “comprising” or any other variation thereof, are intended to cover a non-exclusive inclusion, such that a process, method, article, or apparatus that comprises a list of elements includes not only those elements but also other elements not expressly listed, or also includes elements inherent to such process, method, article, or apparatus. Without further limitation, an element defined by the statement “comprises one” does not rule out there are additional identical elements in the process, method, article, or apparatus that includes the element.

While the present disclosure has been illustrated and described with reference to certain preferred embodiments thereof, it should be understood by those of ordinary skill in the art that various changes may be made in form and detail without departing from the scope of the present disclosure.

1.-26. (canceled)

27. A second device, comprising:
a memory for storing instructions; and
one or more processors for executing the instructions to cause the second device to perform operations including:
receiving a first request from a first device, wherein the first request requests a state shift of a first channel between the first device and the second device from an inactive state to an active state;
transmitting a first signal through a second channel to a third device, when detecting channels between the second device and the third device including the second channel in the inactive state and the first channel in the active state, wherein the first signal is formerly transmitted by the second device to the third device through the first channel; and
communicating with the first device through the first channel, making a state of the first channel between the first device and the second device to be shifted into the active state.

28. The second device of claim 27, the operations further comprising:
adjusting power of the second channel from a first power to a second power during time periods when the second device transmits the first signal to the third device through the second channel, wherein the first power is of the second channel in the inactive state, and the second power is power when the second channel transmits the first signal,
wherein the power of the second channel is adjusted for a first number of times, a power shift value adjusted for each time period is a first quotient of a difference between the first power and the second power and the first number of times, and a length of each time period is a second quotient of a total length of time required to adjust the first power to the second power and the first number of times.

29. The second device of claim 27, the operations further comprising:
shifting the state of the first channel into the inactive state when a first communication condition is met.

30. The second device of claim 29, wherein the shifting the state of the first channel into the inactive state when the first communication condition is met comprises:
adjusting power of the first channel from a third power to a fourth power during time periods, wherein the third power is of the first channel in the active state, and the fourth power is of the first channel in the inactive state,
wherein the power of the first channel is adjusted for a second number of times, a power shift value adjusted for each time period is a first quotient of a difference between the third power and the fourth power and the second number of times, and a length of each time period is a second quotient of a total length of time required to adjust the third power to the fourth power and the second number of times.

31. The second device of claim 30, wherein the first communication condition comprises:
transmitting a second signal through the first channel to the third device, when transmitting the first signal through the second channel to the third device, wherein the first signal and the second signal are the same;
receiving a first message from the third device, wherein the first message indicates that the third device has received the first signal and the second signal; and
aligning pointers to a start of a frame of a third signal and a fourth signal, wherein the third signal is received by the second device through the second channel from the third device, the fourth signal is received by the second device through the first channel from the third device, and the third signal and the fourth signal are the same.

32. The second device of claim 31, wherein the aligning the pointers to the start of the frame of the third signal and the fourth signal comprises:
calculating a cross-correlation function of the third signal and the fourth signal, wherein the cross-correlation function indicates a time delay between the third signal and the fourth signal; and
aligning the pointers to the start of the frame of the third signal and the fourth signal based on the cross-correlation function.

33. A third device, comprising:
a memory for storing instructions; and
one or more processors for executing the instructions to cause the third device to perform operations including:
receiving a third instruction from a second device; and
receiving a first signal through a second channel from the second device, and shifting a state of a first channel between the third device and the second device into an inactive state in response to the third instruction, wherein the first signal is formerly transmitted by the second device to the third device through the first channel.

34. The third device of claim 33, wherein the shifting the state of the first channel between the third device and the second device into the inactive state comprises:
adjusting power of the first channel from a fifth power to a sixth power during time periods, wherein the fifth power is of the first channel in an active state, and the sixth power is of the first channel in the inactive state,
wherein the power of the first channel is adjusted for a third number of times, a power shift value adjusted for each time period is a first quotient of a difference between the fifth power and the sixth power and the third number of times, and a length of each time period is a second quotient of a total length of time required to adjust the fifth power to the sixth power and the third number of times.

35. The third device of claim 33, the operations further comprising:
receiving a second signal through the first channel from the second device when receiving the first signal, wherein the first signal and the second signal are the same; and
aligning pointers to a start of a frame of the first signal and the second signal.

36. The third device of claim 35, wherein the aligning the pointers to the start of the frame of the first signal and the second signal comprises:
calculating a cross-correlation function of the first signal and the second signal, wherein the cross-correlation function indicates a time delay between the first signal and the second signal; and
aligning the pointers to the start of the frame of the first signal and the second signal based on the cross-correlation function.

37. The third device of claim 33, the operations further comprising:
transmitting a third signal through the second channel to the second device in response to the third instruction, wherein the third signal is formerly transmitted by the third device to the second device through the first channel; and
adjusting power of the second channel from a seventh power to an eighth power during time periods when the third device transmits the third signal to the second device, wherein the seventh power is of the second channel in the inactive state, and the eighth power is power when the second channel transmits the third signal,
wherein the power of the second channel is adjusting for a fourth number of times, a power shift value adjusted for each time period is a first quotient of a difference between the seventh power and the eighth power and the fourth number of times, and a length of each time period is a second quotient of a total length of time required to adjust the seventh power to the eighth power and the fourth number of times.

38. The third device of claim 33, the operations further comprising:
receiving a second instruction; and
changing the first channel between the second device and the third device through shifting a frequency range of the third device in response to the second instruction.

39. The third device of claim 38, wherein:
the frequency range of the third device includes an analog frequency range and a digital frequency range, and,
the changing the first channel between the second device and the third device through shifting the frequency range of the third device in response to the second instruction comprises:
shifting the analog frequency range of the third device based on a frequency shift step, such that the frequency range of the third device does not include a first frequency range of the first channel, and that the frequency range of the third device includes a second frequency range of the second channel, allowing for future upgrade;
shifting the digital frequency range of the third device based on a fractional digital frequency shift method or a subcarrier recovery method, to compensate a fractional part of the frequency shift step; and
shifting the digital frequency range of the third device based on a de-multiplexing method, to compensate an integer part of the frequency shift step.

40. A method, comprising:
receiving, by a second device, a first request from a first device, wherein the first request requests a state shift of a first channel between the first device and the second device from an inactive state to an active state;
transmitting a first signal, by the second device, through a second channel to a third device when detecting channels between the second device and the third device including the second channel in the inactive state and the first channel in the active state, wherein the first signal is formerly transmitted by the second device to the third device through the first channel; and
communicating with the first device, by the second device, through the first channel, making a state of the first channel to be shifted into the active state.

41. The method of claim 40, further comprising:
adjusting power of the second channel, by the second device, from a first power to a second power during time periods when the second device transmits the first signal to the third device through the second channel, wherein the first power is of the second channel in the inactive state and the second power is power when the second channel transmits the first signal,
wherein the power of the second channel is adjusted for a first number of times, a power shift value adjusted for each time period is a first quotient of a difference between the first power and the second power and the first number of times, and a length of each time period is a second quotient of a total length of time required to adjust the first power to the second power and the first number of times.

42. The method of claim 40, further comprising:
shifting the state of the first channel, by the second device, into the inactive state when a first communication condition is met.

43. The method of claim 42, wherein the shifting the state of the first channel, by the second device, into the inactive state when the first communication condition is met comprises:
adjusting power of the first channel, by the second device, from a third power to a fourth power during time periods, wherein the third power is of the first channel in the active state and the fourth power is of the first channel in the inactive state,
wherein the power of the first channel is adjusted for a second number of times, a power shift value adjusted for each time period is a first quotient of a difference between the third power and the fourth power and the second number of times, and a length of each time period is a second quotient of a total length of time required to adjust the third power to the fourth power and the second number of times.

44. The method of claim 43, wherein the first communication condition comprises:
transmitting a second signal, by the second device, through the first channel to the third device, when transmitting the first signal through the second channel to the third device, wherein the first signal and the second signal are the same;
receiving a first message, by the second device, from the third device, wherein the first message indicates that the third device has received the first signal and the second signal; and
aligning, by the second device, pointers to a start of a frame of a third signal and a fourth signal, wherein the third signal is received by the second device through the second channel from the third device, the fourth signal is received by the second device through the first channel from the third device, and the third signal and the fourth signal are the same.

45. The method of claim 44, wherein the aligning, by the second device, the pointers to the start of the frame of the third signal and the fourth signal comprises:
calculating a cross-correlation function, by the second device, of the third signal and the fourth signal, wherein the cross-correlation function indicates a time delay between the third signal and the fourth signal; and
aligning, by the second device, the pointers to the start of the frame of the third signal and the fourth signal based on the cross-correlation function.

46. A method, comprising:
receiving a third instruction, by a third device, from a second device; and
receiving a first signal, by the third device, through a second channel from the second device, and shifting a state of a first channel between the third device and the second device into an inactive state in response to the third instruction, wherein the first signal is formerly transmitted by the second device to the third device through the first channel.

47. The method of claim 46, wherein the shifting the state of the first channel between the third device and the second device into the inactive state comprises:
adjusting a power of the first channel, by the third device, from a fifth power to a sixth power during time periods, wherein the fifth power is of the first channel in an active state, and the sixth power is of the first channel in the inactive state,
wherein the power of the first channel is adjusted for a third number of times, a power shift value adjusted for each time period is a first quotient of a difference between the fifth power and the sixth power and the third number of times, and a length of each time period is second quotient of a total length of time required to adjust the fifth power to the sixth power and the third number of times.

48. The method of claim 46, further comprising:
receiving a second signal, by the third device, through the first channel from the second device when receiving the first signal, wherein the first signal and the second signal are the same; and
aligning, by the third device, pointers to a start of a frame of the first signal and the second signal.

49. The method of claim 48, wherein the aligning, by the third device, the pointers to the start of the frame of the first signal and the second signal comprises:
calculating a cross-correlation function, by the third device, of the first signal and the second signal, wherein the cross-correlation function indicates a time delay between the first signal and the second signal; and
aligning, by the third device, the pointers to the start of the frame of the first signal and the second signal based on the cross-correlation function.

50. The method of claim 46, further comprising:
transmitting a third signal, by the third device, through the second channel to the second device in response to the third instruction, wherein the third signal is formerly transmitted by the third device to the second device through the first channel; and
adjusting power of the second channel, by the third device, from a seventh power to an eighth power during time periods when the third device transmits the third signal to the second device, wherein the seventh power is of the second channel in the inactive state and the eighth power is power when the second channel transmits the third signal,
wherein the power of the second channel is adjusted for a fourth number of times, a power shift value adjusted for each time period is a first quotient of a difference between the seventh power and the eighth power and the fourth number of times, and a length of each time period is a second quotient of a total length of time required to adjust the seventh power to the eighth power and the fourth number of times.

51. The method of claim 46, further comprising:
receiving a second instruction, by the third device; and
changing the first channel, by the third device, between the second device and the third device through shifting a frequency range of the third device in response to the second instruction.

52. The method of claim 51, wherein:
the frequency range of the third device includes an analog frequency range and a digital frequency range, and
the changing the first channel, by the third device, between the second device and the third device through shifting the frequency range of the third device in response to the second instruction comprises:
shifting the analog frequency range of the third device, by the third device, based on a frequency shift step, such that the frequency range of the third device does not include a first frequency range of the first channel, and such that the frequency range of the third device includes a second frequency range of the second channel, allowing for future upgrade;
shifting the digital frequency range of the third device, by the third device, based on a fractional digital frequency shift method or a subcarrier recovery method, to compensate a fractional part of the frequency shift step; and
shifting the digital frequency range of the third device, by the third device, based on de-multiplexing method, to compensate an integer part of the frequency shift step.
